(19) United States
(12) Patent Application Publication
(10) Pub. No.: US 2016/0179816 A1
(43) Pub. Date: Jun. 23, 2016

(54) Near Real Time Auto-Suggest Search Results

(71) Applicant: Quixey, Inc., Mountain View, CA (US)

(72) Inventor: Eric J. Glover, Palo Alto, CA (US)

(73) Assignee: Quixey, Inc., Mountain View, CA (US)

(21) Appl. No.: 14/971,276

(22) Filed: Dec. 16, 2015

Related U.S. Application Data
(60) Provisional application No. 62/095,520, filed on Dec. 22, 2014.

(51) Int. Cl. G06F 17/30

(52) U.S. Cl. CPC G06F 17/3053; G06F 17/30424

(57) ABSTRACT

A method includes receiving an indication from a user device of one or more installed applications on the user device, receiving a partial search query from the user device, and identifying one or more application states of the one or more installed applications based on the partial search query and auto-suggest data. The auto-suggest data associates application states of the one or more installed applications with keywords corresponding to the respective application states and is at least partially based on content feed data corresponding to application states of the one or more installed applications. The method further includes generating auto-suggest search results including one or more application access mechanisms of the identified one or more application states and transmitting the auto-suggest search results to the user device.

### CROSS REFERENCE TO RELATED APPLICATIONS

This U.S. patent application claims priority under 35 U.S.C. §119(e) to U.S. Provisional Application 62/095,520, filed on Dec. 22, 2014, which is hereby incorporated by reference in its entirety.

### TECHNICAL FIELD

This disclosure relates to providing near real time search results.

### BACKGROUND

In recent years, use of computers, smartphones, and other Internet-connected devices has grown exponentially. Correspondingly, the number of available software applications for such devices has also grown. Today, many diverse native and web software applications can be accessed on any number of different devices, including, but not limited to, smartphones, personal computers, automobiles, and televisions. At least some of those applications include some sort of search capabilities to identify and access content. In general, near real time search refers to the concept of having documents available for search almost immediately after being indexed, so that additions and updates to documents are seen in ‘near’ real time or at least after some commit period.

### SUMMARY

One aspect of the disclosure provides a method for providing near real time search results. The method includes receiving, at data processing hardware, an indication from a user device of one or more installed applications on the user device, receiving, at the data processing hardware, a partial search query from the user device, and identifying, by the data processing hardware, one or more application states of the one or more installed applications based on the partial search query and auto-suggest data. The auto-suggest data associates application states of the one or more installed applications with keywords corresponding to the respective application states and is at least partially based on content feed data corresponding to application states of the one or more installed applications. The content feed data is obtained from a plurality of different content feeds. Moreover, each content feed is accessed by a crawler executed by the data processing hardware. The method further includes generating, by the data processing hardware, auto-suggest search results including one or more application access mechanisms of the identified one or more application states and transmitting the auto-suggest search results from the data processing hardware to the user device. Each application access mechanism has a reference to a corresponding installed application and is configured to access the corresponding identified application state using the corresponding installed application.

Implementations of the disclosure may include one or more of the following optional features. In some implementations, the content feed data includes a set of documents obtained from the plurality of content feeds. Each document corresponds to an application state of a respective application, is accessible using an application access mechanism corresponding to the application state, and defines content presented at the application state.

The method may include identifying, by the data processing hardware, the plurality of content feeds and, for each content feed: creating, by the data processing hardware, a content feed record corresponding to the content feed; and periodically obtaining, by the data processing hardware, new documents from the content feed using the address defined in the content feed record. The content feed record defines an address from which to obtain newly published documents on the content feed. For each new document, the method may include: identifying, by the data processing hardware, new content feed data defined in the document and a new application access mechanism corresponding to the new document; identifying, by the data processing hardware, one or more keywords pertaining to the document; generating, by the data processing hardware, an application state record based on the new content feed data, and the new application access mechanism; and updating, by the data processing hardware, the autosuggest data based on the application state record and the one or more keywords. Moreover, for at least one new document, the method may include: scraping, by the data processing hardware, the new document to identify a title of the new document; generating, by the data processing hardware, a second application access mechanism corresponding to a different application than the application that provides the new document based on an access mechanism template corresponding to the different application and the title obtained from the new document; generating, by the data processing hardware, a second application state record corresponding to the different application based on the second application access mechanism; and updating, by the data processing hardware, the autosuggest data based on the second application state record and the one or more keywords. In some examples, the plurality of content feeds includes one or more Rich Site Summary feeds.

In some implementations, identifying the one or more application states of the one or more installed applications includes searching an index of documents having name-value pairs for keywords containing or beginning with the partial search query. Each name-value pair corresponds to a keyword, and each document is associated with an application state. In additional implementations, identifying the one or more application states of the one or more installed applications includes searching auto-suggest data blocks for keywords containing or beginning with the partial search query. Each auto-suggest data block associates a keyword with an application state of a corresponding installed application. Furthermore, each auto-suggest data block associates a keyword with a document representing the corresponding application state of the corresponding installed application. The document includes at least one of a document title, an application access mechanism for accessing the corresponding application state of the corresponding installed application, a keyword score indicating a degree of relevancy of the keyword to the document, or a document location. In some examples, the application state of the corresponding auto-suggest data block is for accessing content of a content feed. In yet further implementations, identifying the one or more application states of the one or more installed applications includes comparing the partial search query against one or more grammar sets to determine a relevancy of an application state. Each grammar set includes search grammars, and each search grammar has a search expression in the form of modifier:argument. The partial search query matches the expression of the search grammar when a condition specified by the modifier:argument is satisfied. Each search grammar may have an associated grammar score indicating the relevancy of the search grammar to the associated application state.

Another aspect of the disclosure provides another method for providing near real time search results. The method includes receiving, at data processing hardware of a user device, auto-suggest data transmitted from a search system in communication with the data processing hardware. The auto-suggest data associates application states of one or more applications installed on the user device with keywords corresponding to the respective application states and is at least partially based on content feed data corresponding to applications states of the one or more installed applications. The content feed data is obtained from a plurality of different content feeds, and the content feeds are accessed by a crawler of the search system. The method further includes receiving, by the data processing hardware via a search field presented in a user interface of the user device, a partial search query at the data processing hardware and identifying, by the data processing hardware, one or more application states of the one or more installed applications based on the partial search string and the auto-suggest data. The method includes generating, by the data processing hardware, auto-suggest search results including one or more application access mechanisms of the identified one or more application states and displaying, by the data processing hardware, the auto-suggest search results on the user interface of the user device. Each application access mechanism has a reference to a corresponding installed application and is configured to access the corresponding identified application state using the corresponding installed application.

Implementations of this aspect may include one or more of the following optional features. In some implementations, the content feed data includes a set of documents obtained from the plurality of content feeds. Each document corresponds to an application state of a respective application, is accessible using an application access mechanism, and defines content presented at the application state.

In some implementations, identifying the one or more application states of the one or more installed applications includes searching an index of documents having name-value pairs for keywords containing or beginning with the partial search query. Each name-value pair corresponds to a keyword, and each document is associated with an application state. In additional implementations, identifying the one or more application states of the one or more installed applications includes searching auto-suggest data blocks for keywords containing or beginning with the partial search query. Each auto-suggest data block associates a keyword with an application state of a corresponding installed application. Moreover, each auto-suggest data block associates a keyword with a document representing the corresponding application state of the corresponding installed application. The document includes at least one of a document title, an application access mechanism for accessing the corresponding application state of the corresponding installed application, a keyword score indicating a degree of relevancy of the keyword to the document, or a document location. The application state of the corresponding auto-suggest data block may be for accessing content of a content feed. In further implementations, identifying the one or more application states of the one or more installed applications includes comparing the partial search query against one or more grammar sets to determine a relevancy of an application state. Each grammar set includes search grammars, and each search grammar has a search expression in the form of modifier:argument, where the partial search query matches the expression of the search grammar when a condition specified by the modifier:argument is satisfied. Each search grammar may have an associated grammar score indicating the relevancy of the search grammar to the associated application state. The method may include periodically receiving the auto-suggest data from the search system and periodically transmitting, from the data processing hardware to the search system, an indication of the one or more applications installed on the user device.

In some implementations, the method includes receiving, by the data processing hardware via the user interface, one of a selection of one of the autosuggest search results and additional text via the search field and selection of a search execution command. In response to selection of one of the autosuggest search results, the method includes accessing, by the data processing hardware, the application state indicated by the selected autosuggest search result using the application access mechanism corresponding to the selected autosuggest search result. In response to selection of the search execution command, the method includes: transmitting, by the data processing hardware, a search query indicating the partial search query and the additional text to the search system; and receiving, by the data processing hardware, search results responsive to the search query.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a schematic view of an example environment including a user device in communication with a search system, an auto-suggest system, and content providers.

FIG. 1B is a functional block diagram of a search system interacting with a search system, an auto-suggest system, user devices, and data sources.

FIG. 1C is a functional block diagram of an example user device.

FIGS. 2A and 2B are schematic views of an example user device in communication with a search system.

FIGS. 3A and 3B are schematic views of an example user device in communication with a search system.

FIG. 4 is a functional block diagram of a search system.

FIGS. 5A and 5B are schematic views of an example feed record.

FIGS. 6A and 6B are schematic views of an example application state record.

FIG. 7 is a schematic view of an auto-suggest block for one or more applications.

FIG. 8 is a schematic view of an example auto-suggest grammars/rules for an application.

FIGS. 9A-9C are schematic views of an example user device displaying search results.

FIG. 10 is a schematic view illustrating an example method for identifying feeds and generating feed records.

FIG. 11 is a schematic view illustrating an example method for crawling content feed of a feed.

FIGS. 12 and 13 are schematic views illustrating an example method for retrieving auto-suggest data from the search system and auto-suggest system.

FIGS. 14 and 15 are schematic views illustrating an example method for retrieving auto-suggest results from the search system and auto-suggest system.

FIG. 16 is a schematic view of an example computing device executing any systems or methods described herein.

Like reference symbols in the various drawings indicate like elements.

### DETAILED DESCRIPTION

The present disclosure describes a system that provides a user with auto-suggest search results based on incremental partial search queries. As the user types a partial search query (e.g., string) into a search field of a search application, the search application displays auto-suggest search results for content viewable through one or more applications installed on the user device. In some implementations, the user device sends an indication to a search system of the one or more installed applications on the user device as well as the partial search query. The search system identifies one or more application states of the one or more installed applications based on the partial search query and auto-suggest data. The auto-suggest data associates application states of the one or more installed applications with keyword strings. The auto-suggest data is also at least partially based on content feed data corresponding to the one or more installed applications. For example, the search system may crawl content feeds for new or updated content and update the content feed data with application access mechanisms that have references to the installed applications and indicate application states for accessing the content of the content feeds. The search system generates and transmits the auto-suggest search results, which include one or more application access mechanisms of the identified one or more application states, to the user device

In other implementations, the user device periodically receives auto-suggest data from the search system and when the user device receives the partial search query, the user device identifies the one or more application states of the one or more installed applications based on the partial search string and the auto-suggest data. The user device then generates the auto-suggest search results, which include the one or more application access mechanisms of the identified one or more application states.

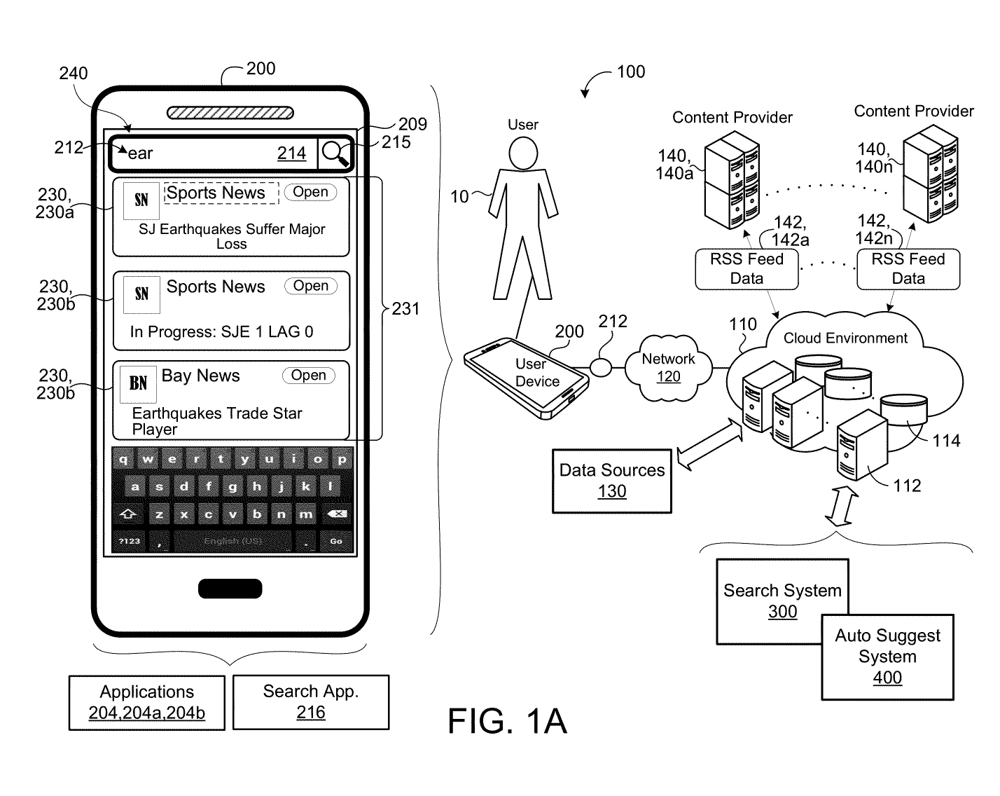

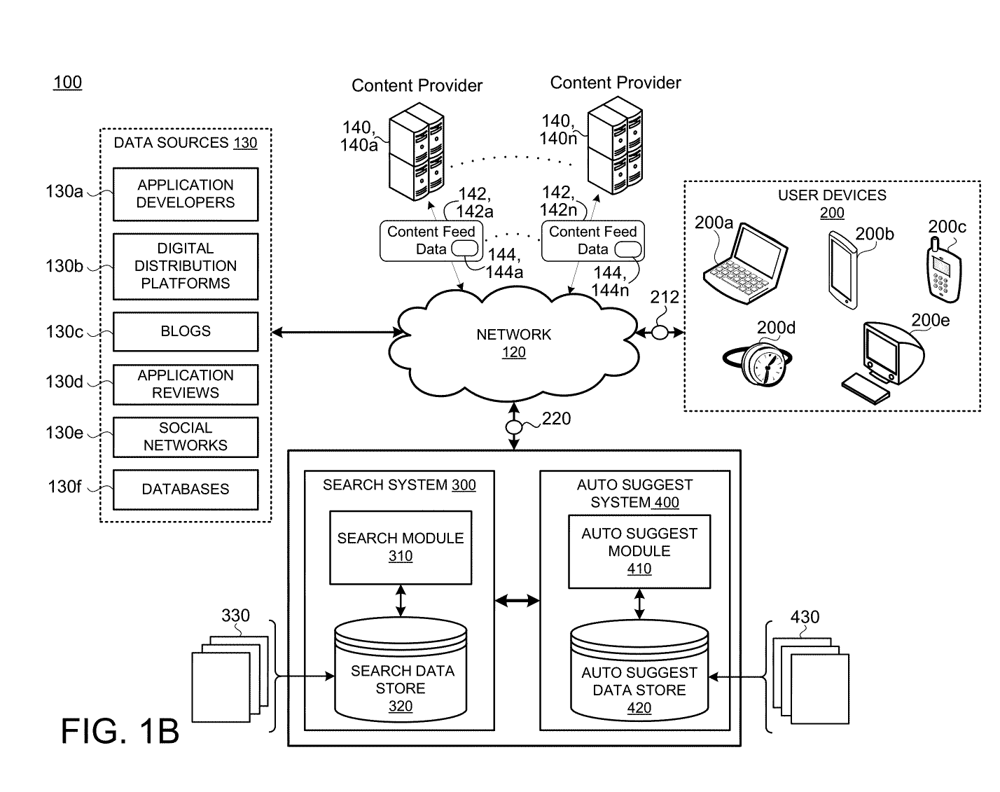

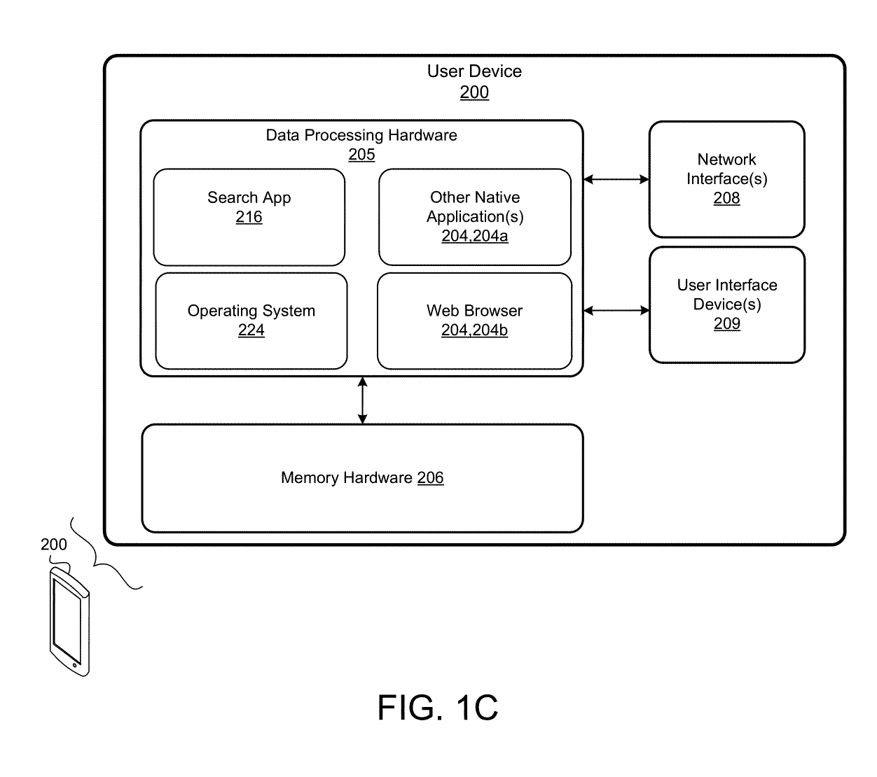

FIG. 1A illustrates an example system 100 that includes a user device 200 associated with a user 10 in communication with a remote system 110 via a network 120. FIG. 1B provides functional block diagrams of the system 100. The remote system 110 may be a distributed system (e.g., cloud environment) having scalable/elastic computing resources 112 and/or storage resources 114. The remote system 110 executes a search system 300 and optionally receives data from one or more data sources 130. The remote system 110 additionally executes an auto-suggest system 400. In some implementations, the auto-suggest system 400 is a component of the search system 300. In other implementations, the search system 300 and the auto-suggest system 400 independently communicate with one or more user devices 200 and the data source(s) 130 via the network 120. The network 120 may include various types of networks, such as a local area network (LAN), wide area network (WAN), and/or the Internet.

FIG. 1C illustrates an example user device 200. The user device 200 can be any computing devices that are capable of providing queries 210, 212 to the search system 300. User devices 200 include, but are not limited to, mobile computing devices, such as laptops 200a, tablets 200b, smart phones 200c, and wearable computing devices 200d (e.g., headsets and/or watches). User devices 200 may also include other computing devices having other form factors, such as computing devices included in desktop computers 200e, vehicles, gaming devices, televisions, or other appliances (e.g., networked home automation devices and home appliances).

The user device 200 may execute one or more software applications 204. A software application 204 may refer to computer software that, when executed by a computing device, causes the computing device to perform a task. In some examples, a software application 204 may be referred to as an “application”, an “app”, or a “program”. Example software applications 204 include, but are not limited to, word processing applications, spreadsheet applications, messaging applications, media streaming applications, social networking applications, and games. In some examples, applications 204 may be installed on the user device 200 prior to a user 10 purchasing the user device 200. In other examples, the user 10 may download and install applications 204 on the user device 200.

The user device 200 may use a variety of different operating systems 224. In examples where the user device 200 is a mobile device, the user device 200 may run an operating system including, but not limited to, ANDROID® developed by Google Inc., IOS® developed by Apple Inc., or WINDOWS PHONE® developed by Microsoft Corporation. Accordingly, the operating system 212 running on the user device 200 may include, but is not limited to, one of ANDROID®, IOS®, or WINDOWS PHONE®. In an example where a user device is a laptop or desktop computing device, the user device may run an operating system including, but not limited to, MICROSOFT WINDOWS® by Microsoft Corporation, MAC OS® by Apple, Inc., or Linux. The user device 200 may also access the search system 300 while running an operating system 212 other than those operating systems 224 described above, whether presently available or developed in the future.

The user device 200 in the example shown includes data processing hardware 205 in communication with memory hardware 206, a network interface device 208, and a user interface device 209, such a screen. The user device 200 may include other components not explicitly depicted. In implementations where the data processing hardware 205 includes two or more processors, the processors can execute in a distributed or individual manner. The memory hardware 206 (e.g., random access memory (RAM), read-only memory (ROM), hard disk drive and/or flash memory) stores instructions that when executed on the data processing hardware 205 cause the data processing hardware 205 to perform one or more operations. The memory hardware 206 may store computer readable instructions that make up a native application 204a, a web browser 204b, and/or the operating system 224. The operating system 224 acts as an interface between the data processing hardware 205 and the applications 204. The network interface 208 includes one or more devices configured to communicate with the network 120. The network interface 208 can include one or more transceivers for performing wired or wireless communication. Examples of the network interface 208 may include, but are not limited to, a transceiver configured to perform communications using the IEEE 802.11 wireless standard, an Ethernet port, a wireless transmitter, and a universal serial bus (USB) port. The user interface 209 includes one or more devices configured to receive input from and/or provide output to the user 10. The user interface 209 can include, but is not limited to, a touchscreen, a display, a QWERTY keyboard, a numeric keypad, a touchpad, a microphone, and/or speakers.

In general, the user device 200 may communicate with the search system 300 using any software application 204 that can transmit search queries 212 to the search system 300 or the auto-suggest system 400. In some examples, the user device 200 runs a native application 204a that is dedicated to interfacing with the search system 300 and/or the auto-suggest system 400, such as a native application 204a dedicated to searches (e.g., a search application 216). In some examples, the user device 200 communicates with the search system 300 using a more general application 204, such as a web-browser application 204b accessed using a web browser. Although the user device 200 may communicate with the search system 300 using a native application 204a and/or a web-browser application 204b, the user device 200 may be described hereinafter as using the native search application 216 to communicate with the search system 300.

With continued reference to FIGS. 1A and 1B, the search system 300 includes a search module 310 in communication with a search data store 320. The search data store 320 may include one or more databases, indices (e.g., inverted indices), tables, files, or other data structures, which may be used to implement the techniques of the present disclosure. The search system 300 may also include an auto-suggest system 400. The auto-suggest system 400 includes an auto-suggest module 410 in communication with an auto-suggest data store 420. As previously noted, the auto-suggest module 410 may be included in the search system 300 or it may be a part of an independent system (e.g., auto-suggest system 400) in communication with the search system 300. The user device 200 sends an incremental search query 212 to the search system 300 and/or auto-suggest system 400 to obtain auto-suggest data 430 or auto-suggest search results 220, as will be described further herein. In response to the received search query 212, the auto-suggest system 400 performs a search within the auto-suggest data store 420 for auto-suggest data 430.

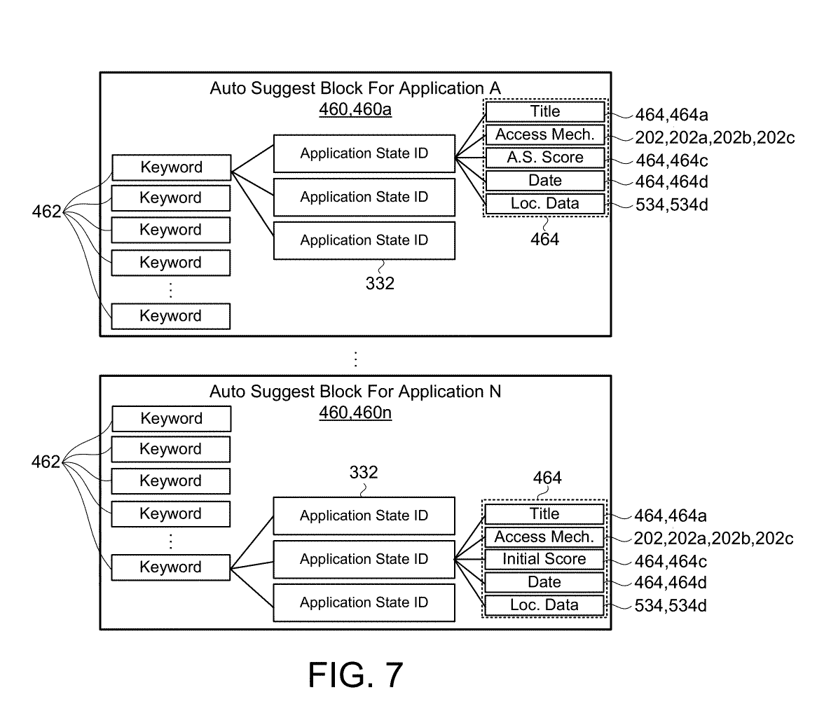

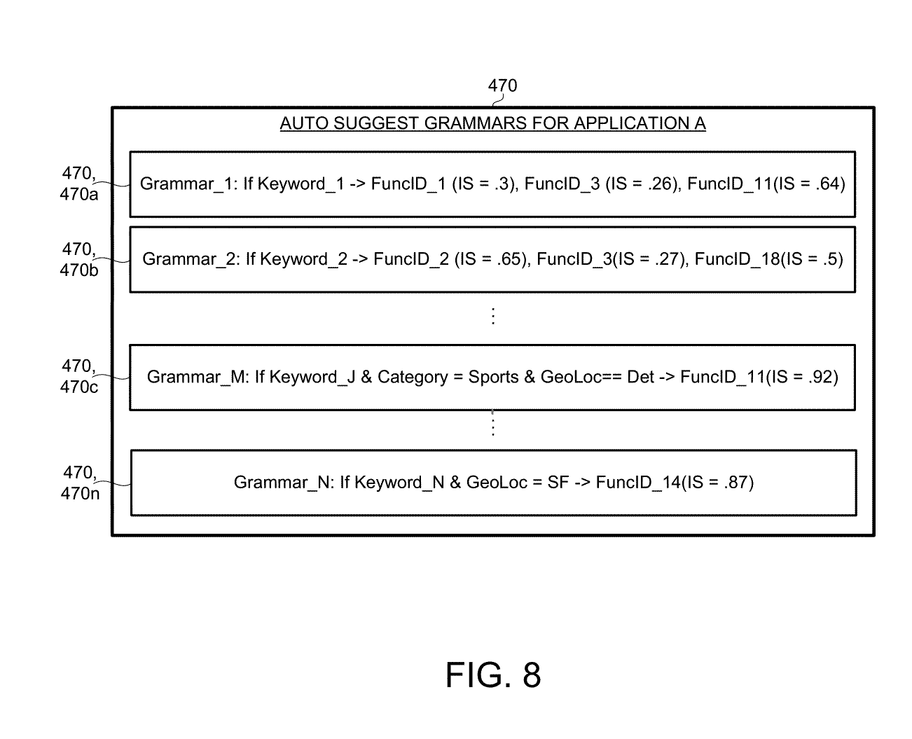

The auto-suggest data 430 includes one or more data structure(s) used to identify the auto-suggest search results 220, which include near-real time data (e.g., documents 144). Examples of auto-suggest data 430 may include, but are not limited to, a near real-time search index 450, auto-suggest data blocks 460 (FIG. 7), and/or auto-suggest grammars 470 (FIG. 8). The auto-suggest data 430 is based on documents 144 obtained from the data sources 130. Auto-suggest data 430 may include near-real time data/information scraped from electronic documents 144, where each document 144 is considered or evaluated by the auto-suggest module 410 using the near real-time index 450, the auto-suggest data blocks 460, and/or the auto-suggest grammars 470.

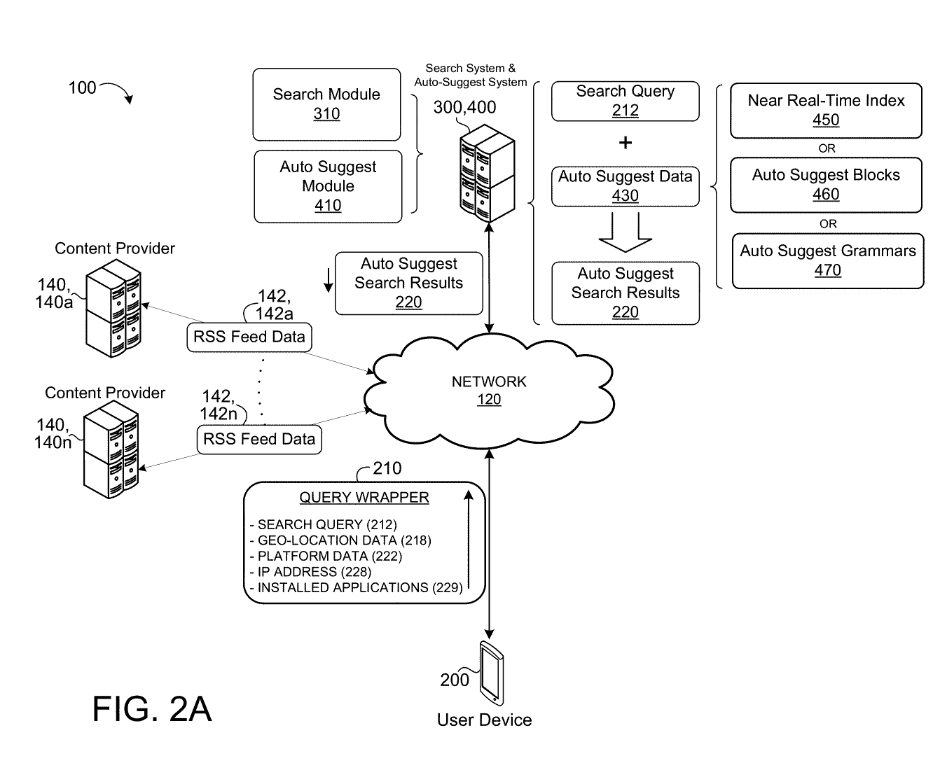

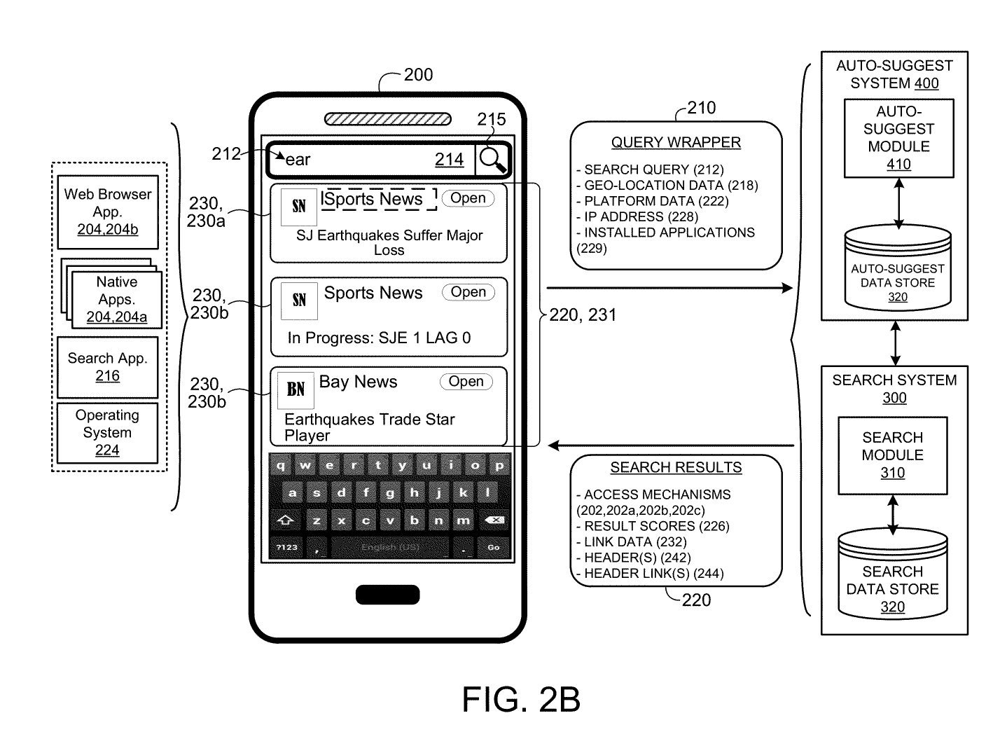

Auto-suggest search results 220 may refer to a set of search results that are identified in response to an incremental search query 212. Near-real time auto-suggest search results 220 enhances an experience of the user 10. For example, it is desirable for the search system 300 to provide auto-suggest search results 220 to the user 10 as the user 10 is typing the search query 212 in a search text box 214 (FIG. 2B) based on user-related data, such as content feeds 142 (e.g., Rich Site Summary (RSS) feeds). Types of content feeds 142 may include, but are not limited to, RSS feeds and Atompub feeds. As shown in FIG. 1A, as the user 10 enters the letters ‘ear’ in the search field 214 (e.g., a search box) of a graphical user interface (GUI) 240 of a search application 216, the GUI 240 displays a list 231 of displayed auto-suggest search results 220 based on the partially entered search query 212 that the user 10 entered into the search field 214. The auto-suggest search results are search results that are identified based on the partial search query. The auto-suggest search results may be based on auto-suggest data. The auto-suggest data may be identified, at least in part, from one or more content feeds 142.

In some implementations, the search system 300 and/or auto-suggest system 400 spiders, crawls, and indexes one or more software applications to identify real-time or near real-time data. In other implementations, the search system 300 and/or auto-suggest system 400 accesses one or more data sources 130 or content providers 140 for data.

The data retrieved from the data sources 130 can include any type of data related to application functionality and/or application states. The search system 300 generates application state records 330 based on the data retrieved from the data sources 130. In some examples, a human operator manually generates some data included in the application state records 330. The search system 300 may update data included in the application state records 330 over time so that the search system 300 provides up-to-date search results 220.

The data sources 130 may include a variety of different data providers. The data sources 130 may include data from application developers 130a, such as application developers' websites and data feeds provided by developers. The data sources 130 may include operators of digital distribution platforms 130b configured to distribute native applications 204a to user devices 200. Example digital distribution platforms 130b include, but are not limited to, the GOOGLE PLAY® digital distribution platform by Google, Inc., the APP STORE® digital distribution platform by Apple, Inc., and WINDOWS PHONE® Store developed by Microsoft Corporation.

The data sources 130 may also include other websites, such as websites that include web logs 130c (i.e., blogs), application review websites 130d, or other websites including data related to applications. Additionally, the data sources 130 may include social networking sites 130e, such as “FACEBOOK®” by Facebook, Inc. (e.g., Facebook posts) and “TWITTER®” by Twitter Inc. (e.g., text from tweets). Data sources 130 may also include online databases 130f that include, but are not limited to, data related to movies, television programs, music, and restaurants. Data sources 130 may also include additional types of data sources in addition to the data sources 130 described above. Different data sources 130 may have their own content and update rate.

Some content providers 140 provide content feeds 142, whereby the content feed 142 provides near real-time data. Examples of content feeds 142 include Rich Site Summary (RSS) feeds 142 or equivalents thereof. RSS utilizes a standard family of Web feed formats to publish frequently updated content, such as blog entries, news articles, audio, and video. Content obtained from a content feed 142 may be referred to as a “feed document” 144. Generally, the broader class of RSS feeds 142 and equivalents thereof may be referred to as “content feeds,” which can also include channel subscriptions. Traditionally, a user 10 subscribes to an RSS feed 142 and a client application (e.g., an RSS reader) monitors a website that provides the RSS feed 142 for new content, allowing the user 10 to receive new content when it becomes available. The auto-suggest system 400 may access the content provides 140 to generate and store auto-suggest data 430 in the auto-suggest data store 420.

Referring to FIGS. 2A and 2B, in some implementations, the user device 200 sends a query wrapper 210, which includes the partial search query 212, to the search system 300 to request auto-suggest search results 220. The search system 300 determines the auto-suggest search results 220 based on the partial search query 212 and returns the auto-suggest search results 220 to the user device 200.

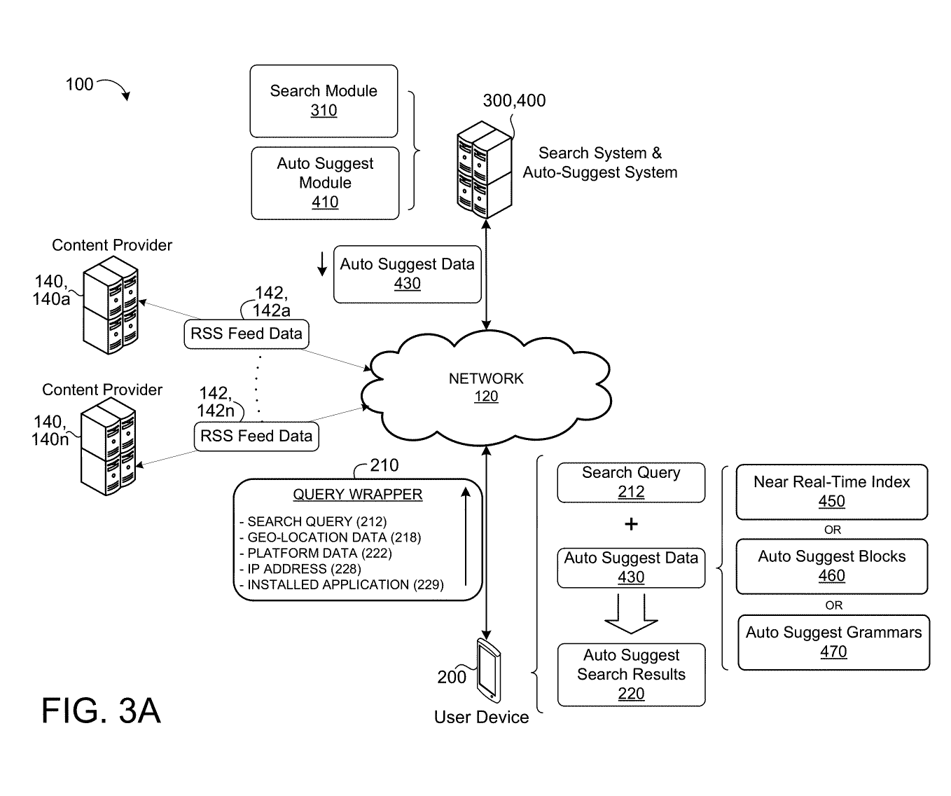

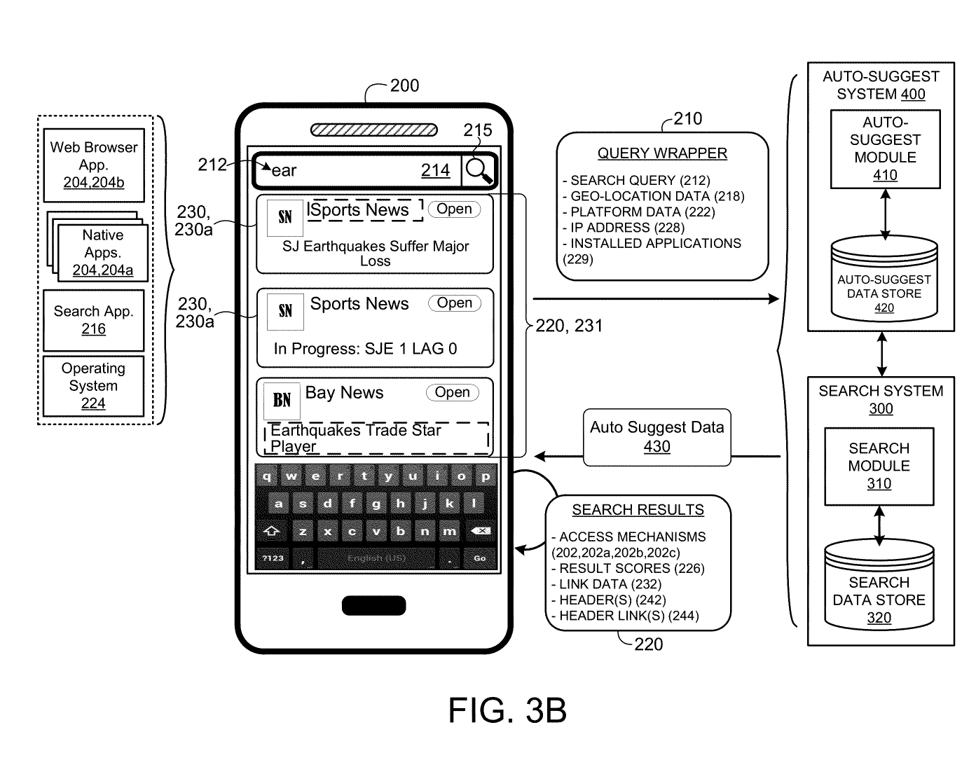

Referring to FIGS. 3A and 3B, in additional implementations, the user device 200 sends a query wrapper 210, which includes the partial search query 212, to the auto-suggest system 400 to request auto-suggest data 430. The auto-suggest system 400 determines the auto-suggest search data 430 based on the partial search query 212 and returns the auto-suggest data 430 to the user device 200, which uses the auto-suggest data 430 to identify the auto-suggest search results 220. In these implementations, the user device 200 may be configured to refrain from transmitting the search query 212 to the search system 300 until the user 10 explicitly executes the search (e.g., presses a search button 215) or indicates that a search is completed by selecting a link 230 of the displayed results 220. In addition, the user device 200 is configured to determine and generate the auto-suggest search results 220 based on the auto-suggest data received from the search system 300.

In some implementations, the user device 200 requests auto-suggest data 430 from the search system 300 or the search system 300 periodically sends the auto-suggest data 430 to the user device 200. The user device 200 uses the received auto-suggest data 430 to identify the auto-suggest search results 220. In some examples, the user device 200 determines and generates the auto-suggest search results 220 based on the received auto-suggest data 430 received from the auto-suggest system 400. In some examples, the auto-suggest system 400 identifies the auto-suggest data 430 to transmit to a particular user device 200 based on the applications 204 installed on the user device 200, the content fees that the user subscribes to, and/or the tendencies of the user (e.g., which websites the user visits often).

In either of the implementations illustrated in FIGS. 2A-3B, the search system 300 or the auto-suggest system 400 provides the user device 200 with auto-suggest search results 220 in response to incremental search queries 212. Incremental search queries 212 refer to search queries 212 that are updated periodically. In some implementations, the search application 216 determines an incremental search query 212 each time the user 10 enters a new character in the search box 214. For example, if the user 10 intends to enter the query term “earthquake,” the user 10 will enter the progression e-a-r-t-h-q-u-a-k-e. In this example, the incremental search queries 212 include {“e,” “ea,” “ear,” “eart” “earth,” “earthq,” “earthqu,” “earthqua,” “earthquak,” and “earthquake,”}. In other implementations, the search application 216 determines an incremental query 212 each time the user pauses while typing. In some implementations, the auto-suggest module 410 or the search application 216 (on the user device 200) monitors the incremental search queries 212 to determine a set of possible query strings, as well as a probability that the possible query string is the intended string. Drawing from the example above, when the user 10 enters “ear” the possible query strings include “ear,” “earth,” “earwax,” “earwig,” and “earthquake.” The possible query strings “ear,” “earth,” “earthquake” are likely to have higher probability scores than “earwig” or “earwax,” assuming the search engine receives more queries containing the former group rather than the latter. The auto-suggest module 410 or the search application 216 can utilize a TRIE to generate the possible query strings. TRIE, also known as a digital tree, radix tree, or prefix tree, is an ordered tree data structure used to store a dynamic set or associative array. The keys in a TRIE may be a string. Other methods for generating query strings are possible as well. The possible query strings may be used to query the auto-suggest data 430.

In other implementations, the incremental search query 212 is only the partial query string entered by the user 10. In these implementations, the auto-suggest data 430 is queried with the partial query string using a “begins with [string]” command or a “includes [command]” command.

In some examples, each time the user 10 enters a search query 212 in the search field 214 of the user device 200, an incremental search query 212 is generated and either the auto-suggest module 410 or the user device 200 attempts to identify auto-suggest search results 220 that may be relevant to the incremental search query 212. The auto-suggest search results 220 are based on the incremental search query 212, auto-suggest data 430, and in some cases, context parameters in a query wrapper 210. Context parameters can refer to additional data that may accompany an incremental search query (or with a search query executed by the user) to provide additional context to the incremental search query 212. For example, the context parameters may include device location data 218 (e.g., geo-location) that indicates the location of the user device 200, such as latitude and longitude coordinates. The user device 200 may include a global positioning system (GPS) receiver that generates the geo-location data 218 transmitted in the query wrapper 210. The context parameters may also include an IP address 228, which the search module 310 may use to determine the location of the user device 200. Other examples of context parameters include, but not limited to, platform data 222 (e.g., version of the operating system 224, device type, and web-browser version), an identity of a user 10 associated with the user device 200 (e.g., a username), partner specific data, and other data. In some examples, the context parameters include installed application data 229 that includes applications 204 installed on the user device 200.

The auto-suggest data 430 may be queried using an incremental search query 212 (which may be a set of possible query strings or just the partial query string) and may output application state identifiers (IDs) 332 (or application state records 330) that point to documents 144 (i.e., RSS documents 144 included in the RSS feeds 142 having near-real time information). Each application state ID 332 uniquely identifies a state of an application 204. An application state ID 332 corresponds to one or more access mechanisms 202 that can be used to access a state of the corresponding application 204. In some implementations, the application state ID 332 includes a Uniform Resource Locator (URL) referencing a functional state of an application 204. In other implementations, the application state ID includes another locator having a different form, e.g., func://exampleapp/param1&param2, which includes the parameters (param1 and param2) that are used to generate the access mechanisms 202.

Access mechanisms 202 may include at least one of a native application access mechanism 202a (hereinafter “application access mechanism”), a web access mechanism 202b, and an application download mechanism 202c. The user device 200 may use the access mechanisms 202 to access functionality of applications 204. For example, the user 10 may select a user selectable link 230 including an access mechanism 202 in order to access functionality of an application 204 indicated in the user selectable link 230. An application access mechanism 202a may be a string that includes a reference to a native application 204a and indicates one or more operations for the user device 200 to perform to enter a certain state of the application 204a. A state to which the native application 204a is set may also be referred to herein as an “application state.” If a user 10 selects a user selectable link 230 including an application access mechanism 202a, the user device 200 may launch the native application 204a referenced in the application access mechanism 202a and perform the one or more operations indicated in the application access mechanism 202a. The search module 310 may transmit one or more application access mechanisms 202a, one or more web access mechanisms 202b, and one or more application download mechanisms 202c to the user device 200 in the search results 220.

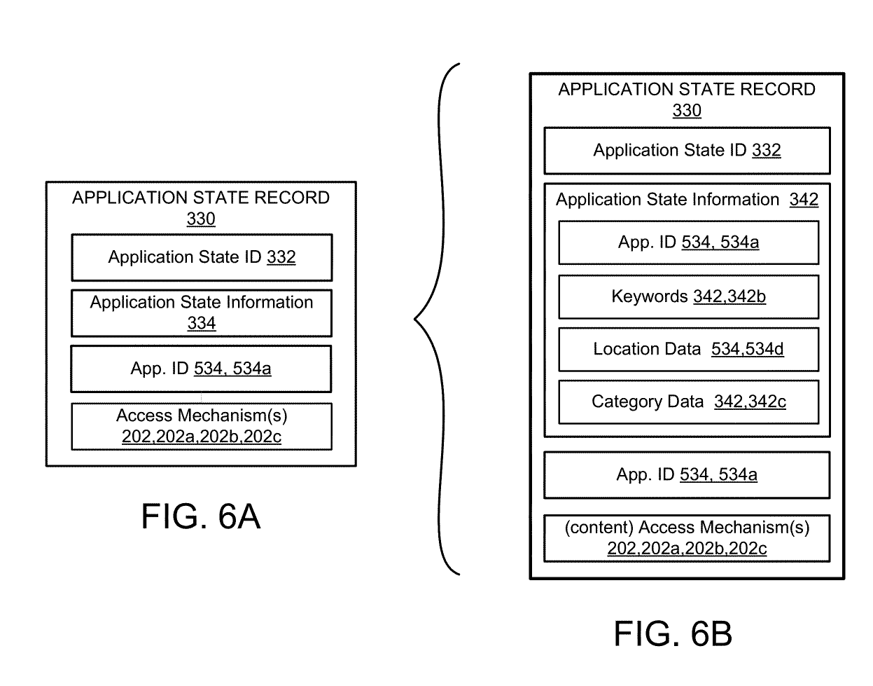

In some implementations, the auto-suggest data 430 includes an initial score 464c (e.g., FIG. 6) for each application state ID 332. The initial score may be a score based on the relevance of the document 144 with the incremental search query 212. The initial score may be a TF-IDF score or a match-based score. TF-IDF (term frequency-inverse document frequency) is a numerical statistic intended to reflect how important a word is to a document in a collection or corpus. The auto-suggest module 410 or the search module 310 can either set the auto-suggest score equal to the initial score or, in some implementations, the auto-suggest module 410 can determine the auto-suggest score based on the initial score. Put another way, the search system 300 can determine the auto-suggest score according to: AS(F_ID)=F(IS), where AS is the auto-suggest score of an application state ID 534a and IS is the initial score of the application state ID 332. In some examples, the initial score includes a factor relating to how recent a document 144 is. For example, a newer document 144 may have a higher initial score than an older document 144. The auto-suggest module 410 or the search application 216 may generate the auto-suggest results 220 based on the application state records 330 corresponding to the selected application state IDs 332. The auto-suggest module 410 or search application 216 can generate a result object (e.g., search result 220) for each selected application state ID 332 using a template and data contained in the application state record 330. In implementations where the search application 216 does the auto-suggesting, the auto-suggest data 430 may be accompanied with the templates, icons, and general data used to generate the result objects.

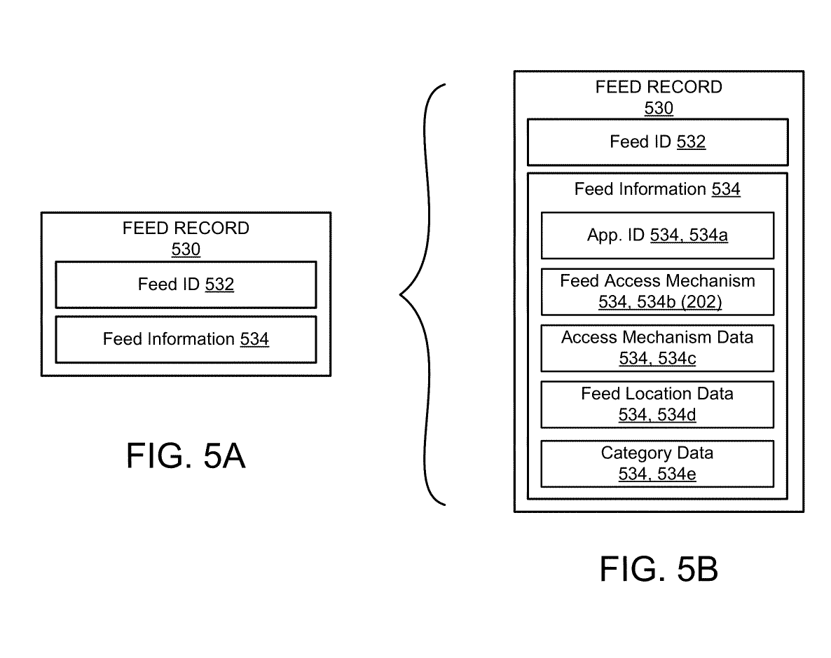

In some implementations, the auto-suggest module 410 or the search application 216 filters auto-suggest results 220 based on the location data of the user device 200 and a feed location of the document 144 or the content feed 142. In this way, the auto-suggest search results 220 are relevant to the user 10. The query wrapper 210 may include geo-location data 218 of the user device 200. Therefore, the search system 300 may use the geo-location data 218 of the user device 200 and the feed location data 534d to identify the auto-suggest results 220. Thus, a user 10 in Detroit does not receive auto-suggest results 220 that are relevant to California. For example, if the user 10 in Detroit inputs “fire” in the search field 214 of the user device 200, the user 10 may not be interested in a local fire in Los Angeles, but the user 10 may be interested in an article about a largescale wildfire across southern California. Information relating to the local fire in Los Angeles is likely found on a local RSS feed 142 pertaining to southern California or Los Angeles, while information relating to the wildfire across southern California may be on a national RSS news feed 142. Thus, the search system 300 uses geo-location data (e.g., feed geo-location 534d) associated with a feed 142 (e.g., a feed record 530) to provide better search results to the user 10 based on the user's geo-location data 218 and the geo-location data 534d associated with a feed record (see FIG. 5A).

Referring back to FIGS. 1A and 1B, the user device 200 generates user selectable links 230 based on the received search results 220. Each user selectable link 230 displayed to the user 10 may include an access mechanism 202. The user 10 may select a user selectable link 230 on the user device 200 by interacting with the link 230 (e.g., touching or clicking the link 230). In response to the user's selection of the link 230, the user device 200 may launch a corresponding software application 204 (e.g., a native application 204a or a web-browser application 204b) referenced by the access mechanism 202 and perform one or more operations indicated in the access mechanism 202.

A link 230 may include text and/or images that the user 10 may select (e.g., touch) via a graphical user interface 240 displayed on a screen 209 (e.g., a display or touch screen) of the user device 200. Each user selectable link 230 may be associated with an application access mechanism 202a such that when the user 10 selects a link 230, the user device 200 launches the native application 204a referenced in the application access mechanism 202a and performs the one or more operations indicated in the application access mechanism 202a. The text and/or images of a link 230 displayed to the user 10 via the screen 209 may indicate the operations that will be performed in response to a selection by the user 10 of the link 230. For example, if the link 230 is to a content feed 142, the link 230 will display text associated with a document 144 associated with the content feed 142, and the link 230 will launch an application 204 that allows the user 10 to view the document 144.

The user 10 may select a link 230 to cause the user device 200 to launch the native application 204a identified in the link 230 and perform one or more operations according to the application access mechanism 202a associated with the link 230. Put another way, when the user 10 selects a link 230, the user device 200 launches a native application 204a and sets the native application 204a into a state defined by the application access mechanism 202a associated with the link. In general, a state of a native application 204a may refer to the operations and/or the resulting outcome of the native application 204a in response to selection of a link 230.

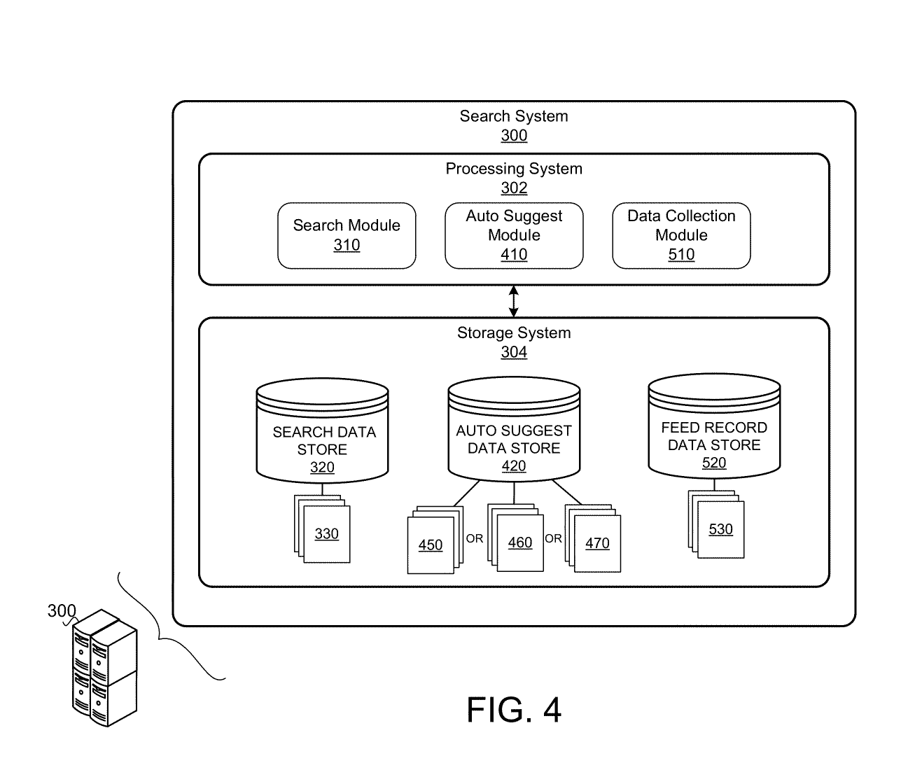

FIG. 4 illustrates an example search system 300 that includes a processing system 302 that executes the search module 310, the auto-suggest module 410, and a data collection module 510, all of which may be embodied by computer-readable instructions. The data collection module 510 identifies content feeds 142 for data or document 144 retrieval. In some implementations, the data collection module 510 searches a digital distribution platform 130b to identify popular applications 204. For these applications 204, the data collection module 510 may identify applications 204 that provide content (e.g., news applications, lifestyle applications, video streaming applications, etc.) and may forego other types of applications (e.g., games, productivity applications, etc.). For each of the content providing applications, the data collection module 510 may obtain a document from a digital distribution platform 130b that corresponds to the content providing application to identify an address of a content feed 142. The data collection module 510 may scrape the requested document to identify a website associated with the content providing application. The data collection module 510 may then crawl and scrape the identified website to identify the address of the content feed 142. For the CNN application as the content providing application, for example, the data collection module 510 may request a document referenced by the following access mechanism: https://play.google.com/store/apps/details?id=com.cnn.mobile.android.phone). In this example, the data collection module 510 scrapes the requested document to identify the “find website” link in the CNN Breaking News app page and reads the corresponding URL (e.g., http://www.cnn.com/). The data collection module 510 then crawls and scrapes the CNN application to identify the RSS feeds 142 offered by the CNN application. After locating the RSS feeds 142, the data collection module 510 parses the website of the content provider 140 to find a link to subscribe to one or more content (RSS) feeds 142 provided by the content provider 140. Once subscribed to the content feed 142, the data collection module 510 creates a feed record 530 (FIG. 5A-5B) corresponding to the content feed 142 (or RSS feed 142).

The search system 300 also includes a storage system 304 in communication with the processing system. The storage system 304 includes the search data store 320 that stores application state records 330, the auto-suggest data store 420 that stores the auto-suggest data 430, and the feed record data store 520 that stores feed records 530.

FIGS. 5A and 5B illustrate exemplary feed records 530 that define data pertaining to a respective content feed 142. Thus, the plurality of feed records 520 correspond to a collection of content feeds 142 identified by the data collection module 510. A feed record 530 may indicate a feed identifier (ID) 532 identifying the content feed 142 and feed information 534. The feed information 534 may include: an application ID 534a of an application that provides the content feed 142; a feed access mechanism 534b from which the content of the content feed 142 is received (e.g., a URL of the content or RSS feed); access mechanism data 534c that defines templates, rules, and/or instructions for generating access mechanisms 534b to access content obtained from the content feed 142; feed location data 534d that indicates geographic regions to which the content feed 142 is pertinent; and feed category data 534e that indicates the different categories of content that are obtained from the content feed 142 (e.g., US News, All News, Sports, Science, Tech, Entertainment, etc.). In some examples, while the data collection module 510 is generating feed records 530, the data collection module 510 also tags the feed record 530 with the location data 534d. The location data 534d is inherited by the application state records 330 that are generated from the content obtained from the content feed 142. Thus, the generated feed geolocation data 534d allows the search system 300 to personalize and localize the feed documents 144 (i.e., the feed contents) to a specific user 10 based on the location of the user 10.

When the data collection module 510 identifies a new content feed 142, the data collection module 510 creates a new feed record 530 corresponding to the content feed 142. Once a content feed 142 is discovered and recorded in a respective feed record 530, the data collection module 510 periodically checks the content feed 142 for any new data or contents or documents 144 (e.g., every few minutes, hours, or days). The data collection module 510 periodically checks the content feeds 142 for updated information for each content feed 142 the data collection module 510 is subscribed to. When the data collection module 510 detects new content or feed documents 144, the data collection module 510 crawls the new content (e.g., a new article) to identify data, such as the title, keywords, any access mechanisms 202 that are used (at the very least the data collection module 510 can identify the URL from which the content was obtained). If the content or documents 144 being crawled do not include application resource identifiers embedded therein, the data collection module 510 can generate application resource identifiers based on the web resource identifiers and the access mechanism data defined in the feed record 530. For example, if the article is referenced by a number in the web URL (e.g., “ . . . /article==1234”) and the template for generating application access mechanisms includes an article number field, the data collection module 510 can generate the application access mechanism by substituting the article number found in the web URL into the template. The data collection module 510 generates an application state record 330 based on the newly crawled content and the identified or generated access mechanisms 202. The data collection module 510 then updates the auto-suggest data 430 with the new application state records 330. The different types of auto-suggest data 430 are discussed further herein.

In some implementations, the data collection module 510 also generates application state records 330 for application states that are not identified directly from the content feeds 142, but rather identified based on the content in the content feeds. For example, these application states may be states of social media applications or content aggregation applications that leverage the search functions of the respective applications 204. In these implementations, the data collection module 510 generates an application state ID 332 that corresponds to the application states. The generated application state ID 332 may be used to access these application states. For example, the data collection module 510 can associate the TWITTER® application or the FLIPBOARD® application to respective content feeds 142 of the CNN® application, THE NEW YORK TIMES® application, the FOX NEWS® application, etc., thereby indicating that when the data collection module 510 obtains new documents 144 from any of these content feeds 142, it is also to generate application state records 330 for TWITTER® or FLIPBOARD® based on the content of the new documents 144. In some examples, the data collection module 510 uses a lookup table (not shown) to identify other applications or may hard code the other applications 204 hard coded into the feed record 530 of a respective content feed 142. The data collection module 510 may then obtain access mechanism data 534c for the other application 204 and generate an application state ID 332 and/or access mechanisms 202 (application resource identifier or script) based on the content or documents 144 of the crawled content feed 142. For example, the data collection module 510 can insert the title of the application 204 into a template for generating access mechanisms 202 for the other application 204. A template for generating a web access mechanisms 202b that leverage the search functionality of the Twitter application may be: “https://twitter.com/search?q=[query_terms]&src=typd”, whereby the title may be substituted for the “[query_terms]. The template may be accompanied with one or more rules (e.g., a rule that stipulates spaces are replaced with “%” symbols). The foregoing is only provided for example of a template for generating an access mechanism. Templates for generating application state IDs may take similar forms. Each application 204 may have a set of corresponding templates. The data collection module 510 can then generate an application state record 330 using the generated application state ID 332 and/or access mechanism 202. The data collection module 510 can utilize keywords extracted from the crawled content or documents 144 to populate the keywords of the new application state record 330.

In some examples, the data collection module 410 crawls a news feed 142 and identifies a new article entitled “Cohen: Why We Haven't Stopped Ebola Yet.” The data collection module 510 scrapes a document 144 representing the article (e.g., an HTML or XML document) to identify the title. The data collection module 510 generates an application state ID 332 and/or one or more access mechanisms 202 using a template and content that was scraped from the document 144 (e.g., the title of the article). For example, the data collection module 510 generates the following access mechanisms 202 to access the twitter search function:

https://twitter.com/search?q=Cohen%3A%20Why%20we%20haven%27t%20stopped%20Ebola&src=typd
twitter:://search?q=Cohen%3A%20Why%20we%20haven%27t%20stopped%20Ebola&s rc=typd
Additionally or alternatively, the search system 300 generates an application state ID 332:
func::twitter:search?q=Cohen%3A%20Why%20we%20haven%27t%20stopped%20Ebol a&src=typd.

In the foregoing examples, the data collection module 510 generates application state records 330 for the Twitter application using the generated application state ID 332 and/or the access mechanisms 202, and the search system 300 populates the application state records 330 with information learned from the originally crawled CNN® article (e.g., with keywords). Thus, when the user 10 enters the search query 212 “ebol,” the auto-suggest results may include a link 230 to the TWITTER® application that is relevant to the search query 212, allowing the user 10 to find tweets about this article on TWITTER® as well as see what other people are saying about the article. In this way, the auto-suggested search results 220 provide links 230 to resources that have not been crawled, but where the auto-suggest system 400 is confident that the user 10 is directed to a relevant resource.

Referring to FIGS. 6A and 6B, the search data store 320 includes a plurality of different application state records 330. Each application state record 330 may include data related to a function of an application 204 and/or the state of the application 204 resulting from performance of the function. An application state record 330 may include an application state identifier (ID) 332, application state information 334, an application identifier (ID) 534a, and one or more access mechanisms 202, 202a, 202b, 202c used to access the state of the application 204 referenced by the application record 330.

The application state ID 332 may be used to identify the application state record 330 among the other application state records 330 included in the search data store 320. Each application state record 330 may be associated with a feed record 530 having associated documents 144. The application state record 330 may provide access to a document 144 of the content feed 142 associated with the feed record 530. In some implementations, an application state ID 332 is a string of alphabetic, numeric, and/or symbolic characters (e.g., punctuation marks) that uniquely identifies a state of an application 204. Put another way, an application state ID 332 is a unique reference to a state of an application. In some implementations, an application state ID 332 can be in the format of a resource identifier. For example, the application state ID 332 may be a uniform recourse locator (URL) or an application resource identifier. In these implementations, the application state ID 332 may be used by a user device 200 to access a web application or one or more editions of a native application 204a, respectively. In some implementations, an application state ID 332 maps to one or more access mechanisms. In these implementations, the application state ID 332 maps to a web resource identifier (e.g., a URL) and/or one or more application resource identifiers. For instance, a state of an example software application, exampleapp, may be accessed via a web application edition and two native application editions (e.g., an edition configured for the ANDROID operating system and an edition configured for the WINDOWS PHONE operating system). In this example, the web resource identifier may be www.exampleapp.com/param1=abc&param2=xyx, the first application resource identifier may be android.exampleapp::param1=abc&param2=xyx, and the second application resource identifier may be windows.exampleapp::param1=abc&param2=xyx. In this example, an application state ID 332 maps to the web resource identifier and the two application resource identifiers. An application state ID 332 may have a URL-like structure that utilizes a namespace other than http://, such as “func://”, which indicates that the string is an application state ID 332. In the example of “exampleapp” above, the application state ID 332 corresponding to the example state may be func://exampleapp::param1=abc&param2=xyx, which maps to the access mechanisms 202 described above. In another example, an application state ID 332 may take the form of a parameterizable function. For instance, an application state ID 332 may be in the form of “app_id[action(parameter_1, . . . , parameter_n)], where app_id is an identifier (e.g., name) of a software application, action is an action that is performed by the application (e.g., “view menu”), and parameter_1 . . . parameter_n are n parameters that the software application receives in order to access the state corresponding to the action and the parameters. Drawing from the example above, an application state ID 332 may be “exampleapp[example_action(abc, xyz)]. Given this application state ID 332 and the referencing schema of the example application, the foregoing application state ID 332 may be used to generate the access mechanisms defined above. Additionally or alternatively, the above example application state ID 332 may map to the access mechanisms defined above. Furthermore, while application state IDs 332 have been described with respect to resource identifiers, an application state ID 332 may map to one or more scripts that access a state of a software application or may be utilized to generate one or more scripts that access a state of the software application. It is noted that some software applications may have a common scheme for accessing all of their respective native application editions. In such scenarios, a single application resource identifier may access multiple application editions.

In an example where the application state ID 332 includes a string in the format of a URL, the application state ID 332 may include the following string “http://www.yelp.com/biz/the-french-laundry-yountville-2?ob=1” to uniquely identify the application state record 330. In additional examples, the application state ID 332 may include a URL using a namespace other than “http://,” such as “func://,” which may indicate that the URL is being used as an application state ID 332 in an application state record 330. For example, the application state ID 332 may include the following string “func://www.yelp.com/biz/the-french-laundry-yountville-2?ob=1.”

The application state information 334 may include data that describes an application state into which an application 204 is set according to the access mechanism(s) 202 in the application state record 330. Additionally or alternatively, the application state information 334 may include data that describes the function performed according to the access mechanism(s) 202 included in the application state record 330. The application state information 334 can include text, numbers, and symbols that describe the application state. The types of data included in the application state information 334 may depend on the type of information associated with the application state and the functionality specified by the application access mechanism 202a. The application state information 334 may include a variety of different types of data, such as structured, semi-structured, and/or unstructured data. The application state information 334 may be automatically and/or manually generated based on documents retrieved from the data sources 130. Moreover, the application state information 334 may be updated so that up-to-date search results 220 can be provided in response to a search query 212.

In some examples, the application state information 334 includes data that is presented to the user 10 by an application 204 when the application 204 is set in the application state defined by the access mechanism(s) 202. For example, if one of the access mechanism(s) 202 is an application access mechanism 202a, the application state information 334 may include data that describes a state of the native application 204a after the user device 200 has performed the one or more operations indicated in the application access mechanism 202a. For example, if the application state record 330 is associated with a shopping application, the application state information 334 may include data that describes products (e.g., names and prices) that are shown when the shopping application is set to the application state defined by the access mechanism(s) 202. As another example, if the application state record 330 is associated with a music player application, the application state information 334 may include data that describes a song (e.g., name and artist) that is played when the music player application is set to the application state defined by the access mechanism(s) 202.

The types of data included in the application state information 334 may depend on the type of information associated with the application state and the functionality defined by the access mechanism(s) 202. For example, if the application state record 330 is for an application 204 that provides reviews of restaurants, the application state information 334 may include information (e.g., text and numbers) related to a restaurant, such as a category of the restaurant, reviews of the restaurant, and a menu for the restaurant. In this example, the access mechanism(s) 202 may cause the application 204 (e.g., a native application 204a or a web-browser application 204b) to launch and retrieve information for the restaurant. As another example, if the application state record 330 is for an application 204 that plays music, the application state information 334 may include information related to a song, such as the name of the song, the artist, lyrics, and listener reviews. In this example, the access mechanism(s) 202 may cause the application 204 to launch and play the song described in the application state information 334.

The search system 300 may generate application state information 334 included in an application state record 330 in a variety of different ways. In some examples, the search system 300 retrieves data to be included in the application state information 334 via partnerships with database owners and developers of native applications 204a. For example, the search system 300 may automatically retrieve the data from online databases 130f that include, but are not limited to, data related to movies, television programs, music, and restaurants. In some examples, a human operator manually generates some data included in the application state information 334. The search system 300 may update data included in the application state information 334 over time so that the search system 300 provides up-to-date results 220.

The application ID 534a may be used to identify a native application 204a associated with the application state record 330. The application ID 534a may be a string of alphabetic, numeric, and/or symbolic characters (e.g., punctuation marks) that uniquely identifies the associated native application 204a. In some examples, the application ID 534a is native application 204a in human readable form. For example, the application ID 534a may include the name of the application 204 referenced in the access mechanism(s) 202. In some examples, the application ID 534a for a restaurant finder application 204 may include the name of the restaurant finder application.

An application state record 330 including an application access mechanism 202 that causes an application 204 to launch into a default state may include application state information 334 describing the native application 204a, instead of any particular application state. For example, the application state information 334 may include the name of the developer of the application 204, the publisher of the application 204, a category 342c (e.g., genre) of the application 204, a description of the application 204 (e.g., a developer's description), keyword 342b relating to the access mechanism 202 content (e.g., documents 144), and the price of the application 204. The application state information 334 may also include security or privacy data about the application 204, battery usage of the application 204, and bandwidth usage of the application 204. The application state information 334 may also include application statistics. Application statistics may refer to numerical data related to a native application 204a. For example, application statistics may include, but are not limited to, a number of downloads, a download rate (e.g., downloads per month), a number of ratings, and a number of reviews. In some examples, the access mechanisms 202 of an application state record 330 are based on or are generated from the feed access mechanism data 534c, which provides a user 10 access to the feed document 144.

In some implementations, an application state record 330 includes multiple different application access mechanisms 202, 202a, 202b, 202c that include a variety of information. The application access mechanism 202 may include edition information that indicates the application edition with which the application access mechanism 202 is compatible. For example, the edition information may indicate the operating system 224 with which the application access mechanism 202 is compatible. Moreover, different application access mechanisms 202 may be associated with different editions of a native application 204a. A native application edition (hereinafter “application edition”) refers to a particular implementation or variation of a native application 204a. For example, an application edition may refer to a version of a native application 204a, such as a version 1.0 of a native application 204a or a version 2.0 of a native application 204a. In another example, an application edition may refer to an implementation of a native application 204a for a specific platform, such as a specific operating system 224.

The different application access mechanisms 202 included in an application state record 330 may cause the corresponding application editions to launch and perform similar functions. Accordingly, the different application access mechanisms 202 included in an application state record 330 may cause the corresponding application editions to be set into similar application states. For example, if the different application access mechanisms 202 reference different editions of an information retrieval application, the different application access mechanisms 202 may cause the corresponding application editions to retrieve similar information. In another example, if the different application access mechanisms 202 reference different editions of an internet music player application, the different application access mechanisms 202 may cause the corresponding application editions to play the same song.

In some examples, an application state record 330 for a native application that retrieves restaurant information may include multiple different application access mechanisms 202 for multiple different application editions. Assuming the application state record 330 is associated with a specific Mexican restaurant, the application access mechanisms 202 for the different application editions may cause each application edition to retrieve information for the same specific Mexican restaurant. For example, a first application access mechanism 202 may cause a first application edition (e.g., on a first OS) to retrieve information for the specific Mexican restaurant. A second application access mechanism 202 may cause a second application edition (e.g., on a second OS) to retrieve information for the specific Mexican restaurant. In some examples, the search system 300 determines whether to transmit the application access mechanism 202 in the search results 220 based on whether the user device 200 can handle the application access mechanism 202.

In some examples, the auto-suggest data 430 includes, but is not limited to, data from the near real-time search index 450 (FIGS. 2A and 3A), auto-suggest data blocks 460 (FIG. 7), and/or auto-suggest grammars 470 (FIG. 8). A near real time search index 450 may be an inverted index that indexes documents 144 that are considered “near real-time.” In some implementations, the near real-time search index 450 can be implemented according to the Lucene software library by the Apache Software Foundation, where each document 144 contains a name-value pair corresponding to a keyword, and each keyword is associated with an application state. Lucene is a high-performance, full-featured text search engine library used for any application that performs full-text search, especially cross-platform. In these implementations, Lucene determines a score (e.g., TF-IDF) at query time. When a new application state record 330 is generated, each entry of a keyword in the index is updated to reflect its association with the application state record 330 (i.e., document 144).

Referring to FIG. 7, an auto-suggest data block 460 (“ASB”) is a data structure that associates keywords 462 to documents 144 that correspond to the keyword 462. In some implementations, the keywords 462 are associated with application state IDs 342a or an application state record 330 (which describes the document 144 having near-real time information). Furthermore, an auto-suggest data block 460 associates the application state ID 332 and/or the application state record 330 to a set of features 464 of the document 144 defined by the application state record 330. In some implementations, the features 464 include a title of the document 464a (e.g., the title of the article), access mechanisms 202, 202a, 202b, 202c used to access the state of the application 204, an initial score 464c, a date 464d of the document 144 (optional), and a location 534d indicating where the document 144 is relevant (optional) or the source location of the document 144. Each auto-suggest data block 460 is application specific, such that each auto-suggest data block 460 corresponds to a different application 204. For instance, CNN®, BBC®, GOOGLE® News, and FOX NEWS® applications 204 may each have a respective auto-suggest data block 460. In this way, user devices 200 (in implementations where the user device 200 determines the auto-suggest search results 220) provide a list of installed applications 229 (in the query wrapper 210) to the auto-suggest module 410 and the auto-suggest module 410 returns only those auto-suggest data block(s) 460 that correspond to the applications 204 installed on the user device 200. For instance, if the auto-suggest module 410 includes auto-suggest data block(s) 460 for Applications A, B, C, and D, and the user device 200 includes Applications C and D installed thereupon, the auto-suggest module 410 returns the auto-suggest data block(s) 460 for Applications C and D to the user device 200 (and not the auto-suggest data block(s) 460 for Applications A and B).

Each time the search system 300 receives/generates an incremental search query 212 (which may be a set of possible query strings), the auto-suggest data block 460 of each application 204 may be queried with the incremental search query 212 (which may be more than one query string). If the search system 300 finds the keyword 462 of the auto-suggest data block 460 of an application 204, then the auto-suggest data block 460 outputs the application state ID 332 and/or the application state record 330 and any information used to generate an auto-suggest search result 220 associated with the application state ID 332 and/or the application state record 330. Furthermore, the auto-suggest data block 460 may output an initial score 464c for each application state ID 332 (i.e., document 144) in the auto-suggest data block(s) 460 as it relates to the keyword 462 that was contained in the search query 212. The auto-suggest initial score 464c may indicate a degree of relevance of the keyword 462 to the document 144. The auto-suggest initial score 464c may be a TF-IDF value of the keyword 462. Thus, if the term “earthquake” appears many times in a document 144 then the term may have a high auto-suggest initial score 464c, but if the term San Jose appears two times in the document, then the keyword may have a lower auto-suggest initial score 464c associated therewith because San Jose appears in a lot more documents 144. The initial score 464c may be determined based on other considerations, such as, but not limited to, the date of the document 144 and/or the location data 534d.

During update time, the data collection module 510 generates a new application state record 330 based on a new document 144 and identifies the keywords 462 of the document 144 (e.g., terms having a TF-IDF greater than a threshold). If the auto-suggest data block 460 already includes an entry for the keyword 462, the data collection module 510 merely adds the application state ID 332 and/or application state record 330 of the newly generated application state record 330 and the other relevant information into the auto-suggest data block 460. This may include the set of calculating the initial score 464c, which may be the TF-IDF. If the keyword is new (e.g., article about the “XYZ Band”), then the data collection module 510 adds the new keyword (e.g., “XYZ Band”) to the auto-suggest data block 460 and associates the application state ID 332 of the newly generated application state record 330 to the new keyword 462, as well as the other information.

Referring to FIG. 8, application-specific auto-suggest grammars 470 are grammar sets 470a-n that determine whether a document 144 (e.g., having near-real time content) is relevant to an incremental search query 212. Each grammar 470 may be a search expression in the form of “modifier:argument.” An incremental search query 212 matches the expression of the grammar 470 when a specified condition is satisfied. Moreover, the matching terms vary by the type of the modifier. As was the case with the implementations of FIG. 6, the user device 200 may request the application-specific auto-suggest grammars 470 from the auto-suggest system. Alternatively, the auto-suggest system may receive indicators of the applications installed on the user device and may process the incremental search query using the application-specific auto-suggest grammars 470 that are relevant to the user device 200. In processing an incremental search query 212, the search application 216 or the auto-suggest module 410 compares the incremental search query 212 (and possibly context parameters of the query wrapper 210) against the grammar set 470a-n defined therein to determine if a document 144 is relevant. If the incremental search query 212 (and potentially one or more context parameters) match to a particular application-specific auto-suggest grammar 470, the application state ID(s) 332 defined in the matched grammar 470 are included a consideration set. Each grammar 470 defined in an application-specific grammar application may have an initial grammar score associated therewith.

In some examples, a first application-specific auto-suggest grammar 470a may determine whether the incremental search query 212 matches a first keyword defined in a first grammar 470a. If so, the application state ID 332 of the application state record 330 referenced in the first grammar 470a is included in a consideration set of application state IDs. The search application 216 or the auto-suggest module 410 may associate an initial score with the application state ID 332. Additionally, a M^{th} grammar 470c may determine if the incremental search query 212 matches a J^{th} keyword defined in the M^{th} grammar 470c and if the context parameters match to a category (e.g., sports) and a location (e.g., Detroit) defined in the M^{th} grammar 470c. If so, the application state ID 332 of the application state record 330 referenced in the M^{th} grammar 470c is included in the consideration set. The search application 216 or the auto-suggest module 410 may associate an initial score with the application state ID 332. The foregoing are examples of application-specific auto-suggest grammars 470. The auto-suggest data may include any other suitable application-specific auto-suggest grammars 470.

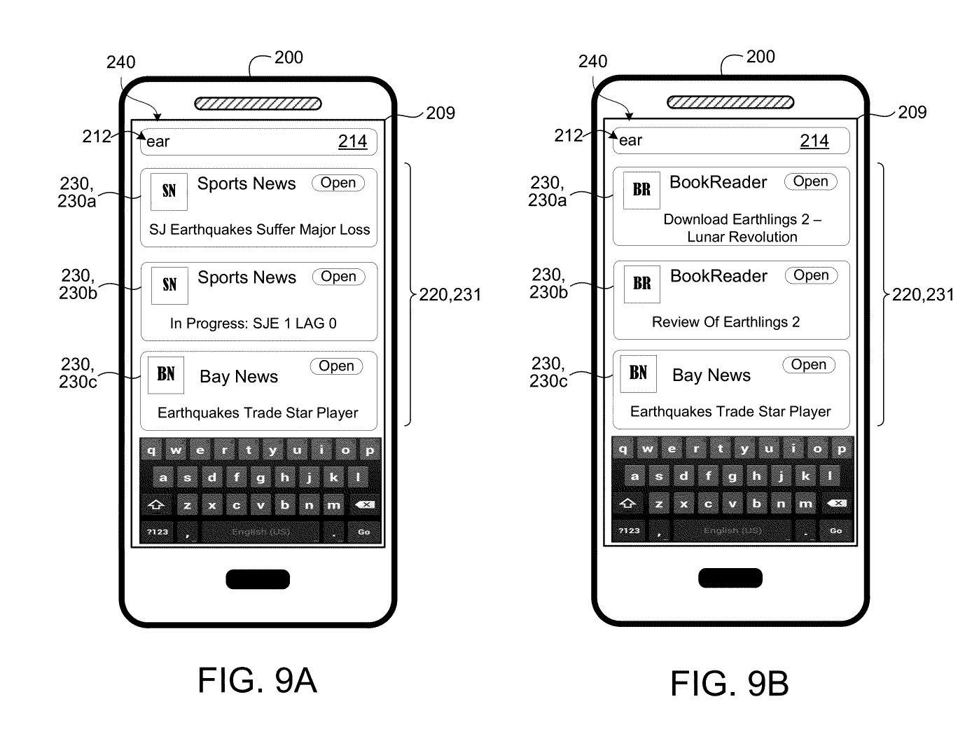

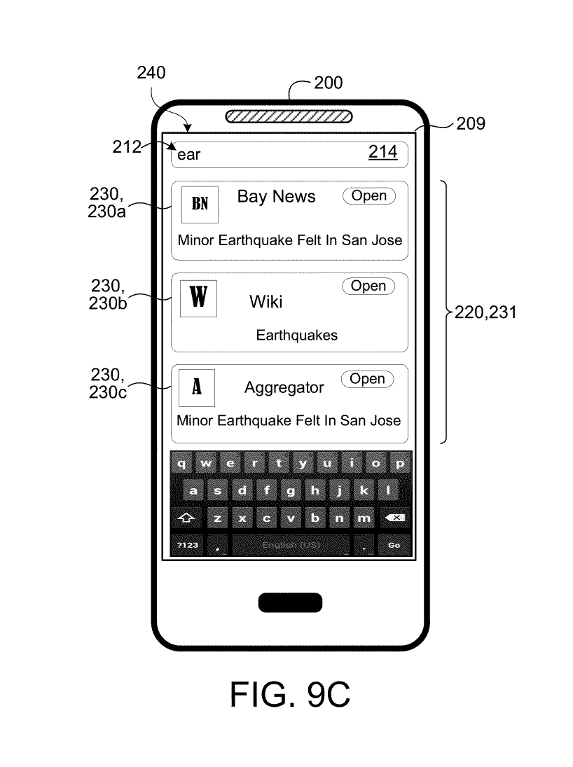

FIGS. 9A-9C illustrate different types of auto-suggest search results 220 that may be presented to different users 10 based on the native applications 204a that each user 10 has installed on his/her user device 200. In the example shown in FIG. 9A, the user 10 has two sports news applications 204 and a News application (e.g., “Bay News”) installed on the user device 200. When the user 10 enters the query string “ear” into the search box 214, the displayed auto-suggest results 220 include user selectable links 230, 230a-c. When the user 10 selects a first user-selectable link 230a, the native applications 204a opens a first sports news application 204 about the San Jose Earthquakes suffering a major loss. When the user 10 selects a second user-selectable link 230b, the native applications 204a opens a second sports news application 204 about the San Jose Earthquakes showing the score of an on-going San Jose Earthquakes game. Furthermore, when the user 10 selects a third user-selectable link 230c, the native applications 204a opens a news application 204 providing an article about earth quakes in the San Jose area.

In another example shown in FIG. 9B, the user 10 has a BookReader application 204 and a news application 204 installed on the user device 200. The auto-suggest system 400 may have previously collected content feeds 142 (e.g., feed documents 144) from the BookReader application that are for a new book called “Earthlings 2” and a review of “Earthlings 2.” Moreover, the auto-suggest system 400 may have collected an article (e.g., a document 144) from the Bay News application about a minor earthquake in San Jose. In this example, the auto-suggest search results 220 are different from those in the above example with reference to FIG. 9A, because the user device 200 has different applications 204 installed, despite entering the same incremental query. In this example, the auto-suggest search results 220, in response to the incremental search query “ear,” include a first user-selectable link 230a to download a copy of Earthlings 2 from BookReader, a second user-selectable link 230b to read a review of Earthlings 2 on BookReader, and a third user-selectable link 230c to read an article about a minor earthquake on the Bay News application. Therefore, the auto-suggest search results 220 are dependent on the native applications 204a that are installed on the user device 200.

In the example illustrated in FIG. 9C, the user 10 may have a Bay News application, a Wiki application, and an Aggregator application (which aggregates syndicated web content, such as online newspaper, blogs, podcasts and video blogs) installed on the user device 200. Again in this example, the auto-suggest search results 220 are different from those in the previous examples with reference to FIGS. 9A and 9B, because the user device 200 has different applications 204 installed, despite entering the same incremental query. In this example, only the Bay News application (see link 230a) has a content feed 142 (e.g., RSS feed), and the Wikipedia application and the Aggregator application do not have any content feeds 142. Therefore, the auto-suggest search results include a first user-selectable link 230a to read an article about a minor earthquake on the Bay News application, a second user-selectable link 230b to the Wiki application, and a third user-selectable link 230b to a state of the Aggregator application that the auto-suggest system 400 determines is likely to exist due to the discovery of the state of the Bay News application indicated in the first user-selectable link 230a. Thus, the auto-suggest system 400 may be assume that if the user selects the third link 230c, the aggregator application may return content relating to the minor earthquake.

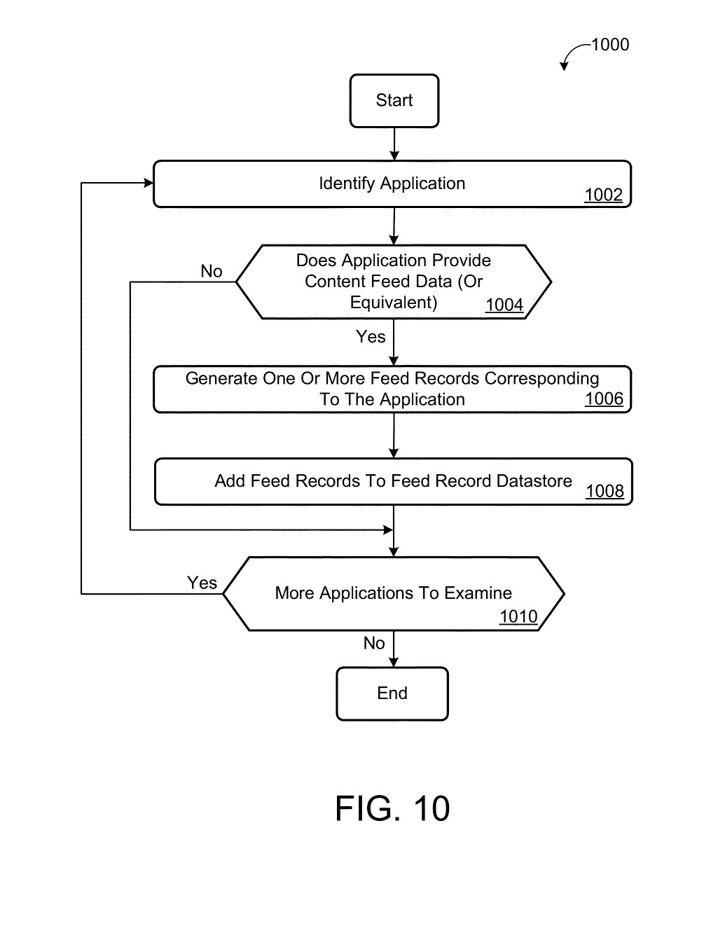

FIG. 10 illustrates an example method 1000 for identifying content feeds 142 and generating feed records 530 corresponding thereto. The method 1000 is described with respect to the auto-suggest system 400. The method, however, may be executed by the search system 300 or other suitable devices. At block 1002, the data collection module 510 identifies an application 204. The data collection module 410 may crawl one or more digital distribution platforms to identify a list of applications offered on the digital distribution platforms. The data collection module 510 may iterate through the list of identified applications. At decision block 1004, the data collection module 510 determines whether the identified application 204 provides a content feed 142. In some implementations, the data collection module 510 obtains a document from the digital distribution platform corresponding to the application. The data collection module 510 may scrape the document to identify a website associated with the application. For example, the data collection module 510 may scrape the document to identify a URL of the website. The data collection module 510 can request one or more additional documents from the application using the identified URL. The additional documents define at least a portion of the website. The data collection module 510 may scrape these additional documents to identify any possible content feeds. If any of the additional documents include a reference to a content feed (the references may be URLs and a tag indicative of a content feed), the data collection module 510 determines that the identified application offers a content feed. If the data collection module 510 determines that the application 204 does not provide content feed 142, then at block 1010, the data collection module 510 determines if there are more applications to analyze.

When the data collection module 510 determines that the application 204 does not provide content feed data 144, then at block 1006, the data collection module 510 generates one or more feed records 530 (FIGS. 5A and 5B) corresponding to the identified application 204. In doing so, the data collection module 510 may subscribe to each of the identified content feeds. For each subscribed to content feed, the data collection module 510 may generate a feed record as described above. In some examples, the data collection module 510 adds a location tag or data 534d to the feed record 530. For example, if the content feed 142 is from a local news feed of detnews.com, which is from a Detroit, Mich. based content provider 140 ‘The Detroit News,’ any feed records 530 associated with detnews.com may include a geolocation tag or data 534d that includes ‘Michigan’ or ‘Detroit.’ At block 1008, the data collection module 510 adds the one or more feed record(s) 530 to the feed record data store 520. Once data collection module 510 adds the feed record(s) 530 associated with the identified application 204 to the feed record database 520, then at block 1010, the search system 300 (e.g., the user device 200 or the search system 300) examines if the user device 200 includes more applications 204 to be examined for feed data or document(s) 144. If so, the data collection module 510 can continue in the manner described above.

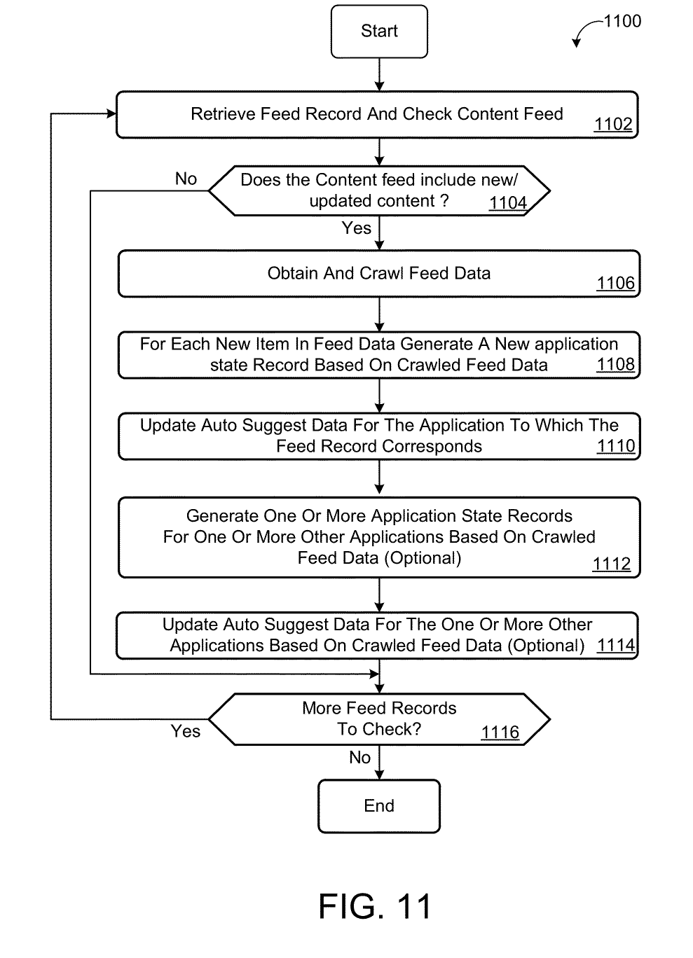

FIG. 11 illustrates an example method 1100 for crawling the content feeds 142 to identify new content in the feed document(s) 144. At block 1102, the search system 300 (e.g., the data collection module 510) retrieves a feed record 530 from a feed data store 520 and checks the content feed 142. At block 1104, the data collection module 510 determines if the content feed 142 includes new/updated content in its document 144. If the data collection module 510 determines that the document 144 associated with the content feed 142 includes new/updated content, then at block 1106 the search system 300 obtains and crawls the feed document(s) 144. For example, the data collection module 510 may request the updated document(s) 144 from the service providers 140. Once the data collection module 510 receives the updated content, then the data collection module 510 may perform any suitable crawling techniques for finding new content. The crawling techniques or policies may include, but are not limited to, selection policy, restricting followed links, URL normalization, path-ascending crawling, focused crawling, academic-focused crawler, re-visit policy, politeness policy and parallelization policy. At block 1108, for each new document 144 or new item in the content feed 142, data collection module 510 generates a new application state record 330 based on the crawled feed documents 144. At block 1110, the search system 300 (via the auto-suggest system 400) updates the auto-suggest data 430 for the application 204 to which the feed record 530 corresponds. For example, the data collection module 510 utilizes a template to generate an application state record 430 by populating the fields (i.e., the application state ID 332, the application state information 342 (including the application ID 534a, keywords 342b, location data 534d, and category data 342c), and access mechanisms 202)) of the template application state record 342 with information obtained from the crawled feed documents 144. The data collection module 510 may populate the access mechanisms fields with access mechanisms 202 corresponding to the state of the application 204. The auto-suggest data 430 may include, but are not limited to, a near real-time search index 450, auto-suggest data blocks 460 (FIG. 7), and/or auto-suggest grammars 470 (FIG. 8). A near real time search index 450 is an inverted index that indexes documents 144 that are considered “near real-time.” An auto-suggest data block 460 (FIG. 7) is a data structure that associates keywords 462 to documents 144 that correspond to the keyword 462. Application-specific auto-suggest grammar sets 470, 470a-n (FIG. 8) determine whether a document 144 is relevant to an incremental search query 212 by evaluating a search expression in the form of “modifier:argument.” The incremental search query 212 matches the expression of the grammar 470 when a specified condition is satisfied. In some examples, at block 1112, the search system 300 generates one or more application state records 330 for one or more other applications 204 that do not provide content feed 142. Additionally, at block 1114, the search system 300 (via the auto-suggest system 400) may update the auto-suggest data 430 for the one or more other applications based on the crawled feed data or documents 144. At block 1116, the search system 300 determines if there are more feed records 530 to check for content 144. If so, the method 1100 continues to execute. Otherwise, the method 1100 ends.

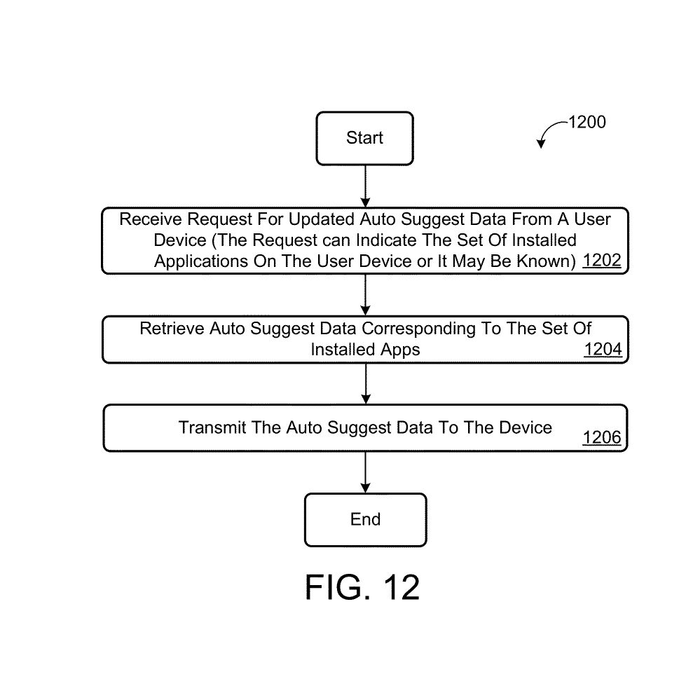

FIG. 12 illustrates an example method 1200 for retrieving auto-suggest data 430. The method is described with respect to the auto-suggest system 400. The method 1200 may be executed by other suitable devices, however, including the search system 300. At block 1202 the auto-suggest module 410 receives, from a user device 200, a request for updated auto-suggest data 430. In some examples, the request includes a list of the installed application 204 on the user device 200. The list of installed applications 229 may be represented using an array where each element identifies a native application 204a installed on the user device 200 or a more compact data structure, such as a Bloom filter that is indicative of a collection of native applications installed on the user device 200. In other examples, the search system 300 keeps track of the application(s) 204 installed on the user device 200 (e.g., noting any applications 204 that the user 10 deletes or installs on the user device 200). At block 1204, the auto-suggest module 410 retrieves auto-suggest data 430 corresponding to the installed applications 229. For each application in the list of installed applications 229, the auto-suggest module 410 can query the auto-suggest data store 420 with an identifier of the application 204. In response, the auto-suggest data store 420 returns auto-suggest data 430 corresponding to the application 204. At block 1206, the auto-suggest module 410 transmits the auto-suggest data 430 to the user device 200. In these implementations, the user device 200 can utilize the auto-suggest data 430 to display auto-suggest results 220, as the user 10 enters a search query 212 into a search box 214.

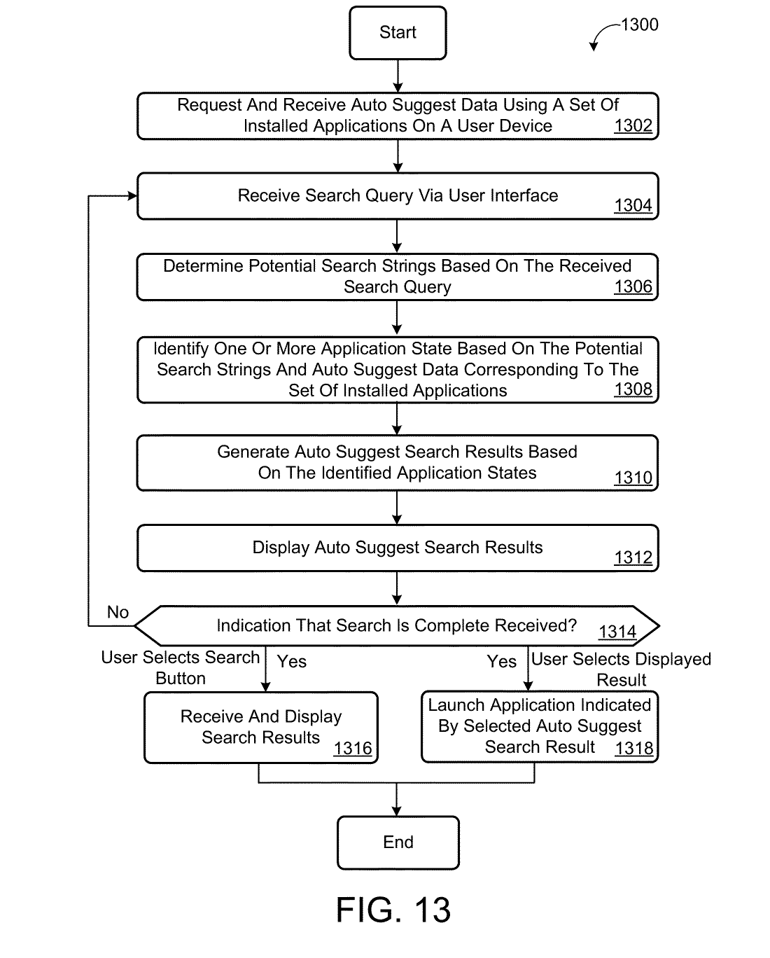

FIG. 13 illustrates an example method 1300 for displaying auto-suggest search results 220 at a user device 200. At block 1302, the user device 200 requests and receives auto-suggest data 430 from the auto-suggest data 400 based on the applications 204 installed on the user device 200. In some examples, the user device 200 periodically requests updates from the search system 300 (see e.g., FIG. 12), while in other examples the search system 300 periodically sends the user device 200 updated auto-suggest data 430. At block 1304, the user device 200 receives an incremental search query 212 (e.g., string) from a user 10 via a GUI displayed by the user device 200. The user device 200 receives the search query incrementally. Thus, blocks 1304 to 1314 may execute incrementally. For example, they may execute at each keystroke or at each time the user device 200 detects a pause while the user is entering the text. At block 1306, the user device 200 determines potential search strings based on the received search query 212. In some implementations, the user device 200 utilizes TRIS to determine the set of potential search strings. In other implementations, the user device 200 utilizes certain commands in lieu of determining the potential search strings (e.g., “begins with [string]” command or a “includes [command]” command). At block 1308, the user device 200 identifies one or more application states of the one or more installed applications 229 (e.g., application state IDs 332 of an application state record 330) based on the potential search strings inputted by a user 10 via a GUI 240 displayed on a screen 209 of the user device 200 and auto-suggest data 430 received from the search system 300 corresponding to the set of installed applications 229 on the user device 200.

In some implementations, identifying the one or more application states of the one or more installed applications 229 entails searching an index of documents having name-value pairs for keywords containing or beginning with the partial search query 212. Each name-value pair corresponding to a keyword and each document is associated with an application state (e.g., an application state ID 332). Additionally or alternatively, the method includes searching auto-suggest data blocks 460 for keywords containing or beginning with the partial search query 212. Each auto-suggest data block 460 associates a keyword with an application state 332 of a corresponding installed application 229. In some examples, each auto-suggest data block associates a keyword with a document 144 representing the corresponding application state 332 of the corresponding installed application 229. As discussed earlier with reference to FIG. 4, the document 144 includes at least one of a document title 464a, an application access mechanism 202 for accessing the corresponding application state of the corresponding installed application 229, a keyword score 464c indicating a degree of relevancy of the keyword to the document 144, or a document location 524d (e.g., a source location). The application state of the corresponding auto-suggest data block 460 is for accessing content of a content feed 142.

In some implementations, identifying the one or more application states 332 of the one or more installed applications 229 includes comparing the partial search query 212 against one or more grammar sets 470 to determine a relevancy of an application state 332. Each grammar set 470 includes search grammars that have a search expression in the form of modifier:argument, where the partial search query 212 matches the expression of the search grammar when a condition specified by the modifier:argument is satisfied. Each search grammar has an associated grammar score indicating the relevancy of the search grammar to the associated application state 332.

At block 1310, the user device 200 generates auto-suggest search results 220 based on the identified application states (e.g., the application state IDs 332). At block 1312, the user device 200 displays auto-suggest search results 220 via the GUI as user-selectable links 230. At block 1314, the user device 200 determines if the user 10 has completed the search. If not, the user device 200 continues to receive user input at the search field 214, as shown at block 1304. The user 10 may complete the search by executing the search (e.g., selecting the search button 215) or by selecting one of the displayed auto-suggest search results 220. Since the search system 300 executes an incremental search, the system 100 performs and narrows down the search with every input received by the GUI from the user device 200. Therefore, the search system 300 identifies two indications that the user 10 has completed a search. The first indication, at block 1316, is when a user 10 selects the search button 215 after inputting search characters. In this case, and in response to the user's selection of the search button 215, the user device 200 transmits a partial search query 212 containing the entered characters in the query search box 214 to the search system 300. The search system 300, in response to receiving the search query 212, transmits search results 220 to the user device 200, which in turn displays the search results 220 on its screen 209 via a GUI 240. The second indication is when the user 10 selects one of the displayed auto-suggest search results 220, where at block 1318, the user device 200 launches the application 204 associated with the user selected link 230. In this case, and in response to the user's selection of one of the displayed search results 220, the user device 200 launches a native application 204a (i.e., application installed on the user device 200) associated with the user's selection and sets the state of the launched native application 204a to the state indicated by the access mechanism 202.

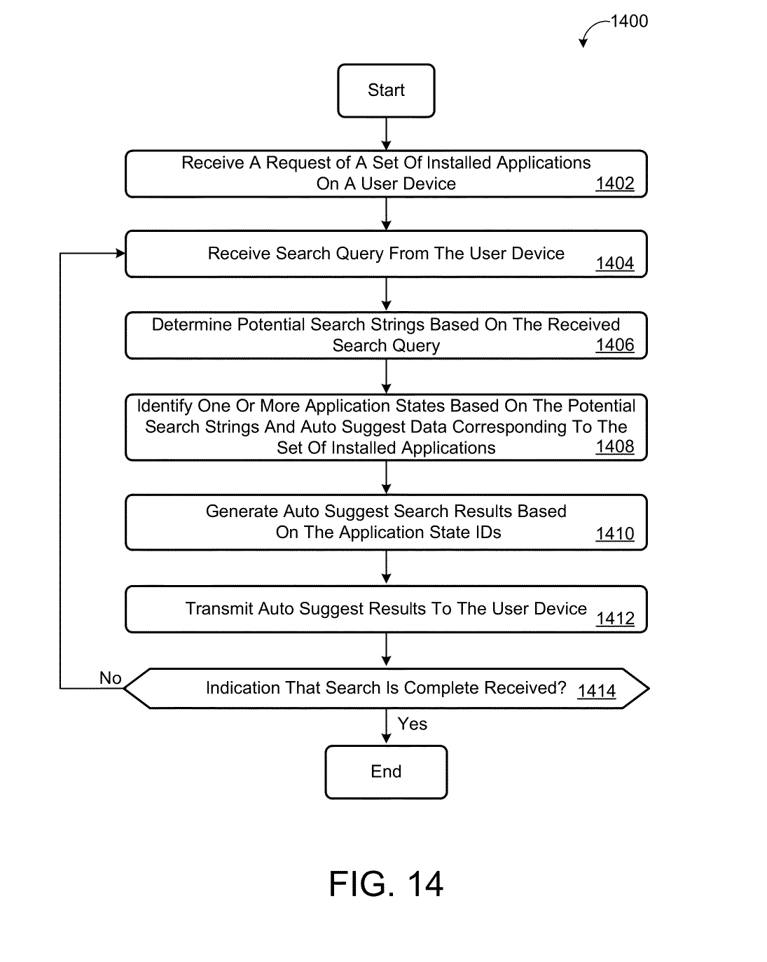

FIG. 14 illustrates an example method 1400 for retrieving auto-suggest results 220 from the search system 300 (including the auto-suggest module 410). At block 1402, the search system 300 (including the auto-suggest system 400) receives a set or list of installed applications 204 from a user device 200. The list of installed applications 229 may be represented using an array where each element identifies a native application 204a installed on the user device 200 or a more compact data structure, such as a Bloom filter that is indicative of a collection of native applications installed on the user device 200. In some examples, the search system 300 periodically requests updates from the user device 200, while in other examples the user device 200 periodically sends the search system 300 updates relating to the installed applications 204. At block 1404, the search system 300 receives a partial search query 212 (e.g., incrementally) from a user 10 via the GUI 240 of the user device 200. At block 1406, the search system 300 determines potential search strings based on the received search query 212 (e.g., using TRIE or a “begins with [string]” command or a “includes [command]” command). At block 1408, the search system 300 identifies one or more application states (e.g., application state IDs 332) based on the potential search strings and auto-suggest data 430 corresponding to the set of installed application 229.

In some implementations, identifying the one or more application states of the one or more installed applications 229 includes searching an index of documents 144 having name-value pairs for keywords containing or beginning with the partial search query 212. Each name-value pair corresponds to a keyword, and each document 144 is associated with an application state. In additional implementations, identifying the one or more application states of the one or more installed applications 229 includes searching auto-suggest data blocks 460 for keywords containing or beginning with the partial search query 212. Each auto-suggest data block 460 associates a keyword with an application state of a corresponding installed application 229. Furthermore, each auto-suggest data block 460 associates a keyword with a document 144 representing the corresponding application state of the corresponding installed application 229. In some examples, the application state of the corresponding auto-suggest data block 460 is for accessing content of a content feed 142. In yet further implementations, identifying the one or more application states of the one or more installed applications 229 includes comparing the partial search query 212 against one or more grammar sets 470 to determine a relevancy of an application state. Each grammar set 470 includes search grammars that have a search expression in the form of modifier:argument, where the partial search query 212 matches the expression of the search grammar when a condition specified by the modifier:argument is satisfied. Each search grammar has an associated grammar score indicating the relevancy of the search grammar to the associated application state 332.

At block 1410, the user device 200 generates auto-suggest search results 220 based on the identified application states (e.g., application state IDs 332). At block 1412, the search system 300 transmits the auto-suggest search results 220 to the user device 1412. At block 1414, the system 100 waits for an indication that the search is completed and the search query 212 has been received.

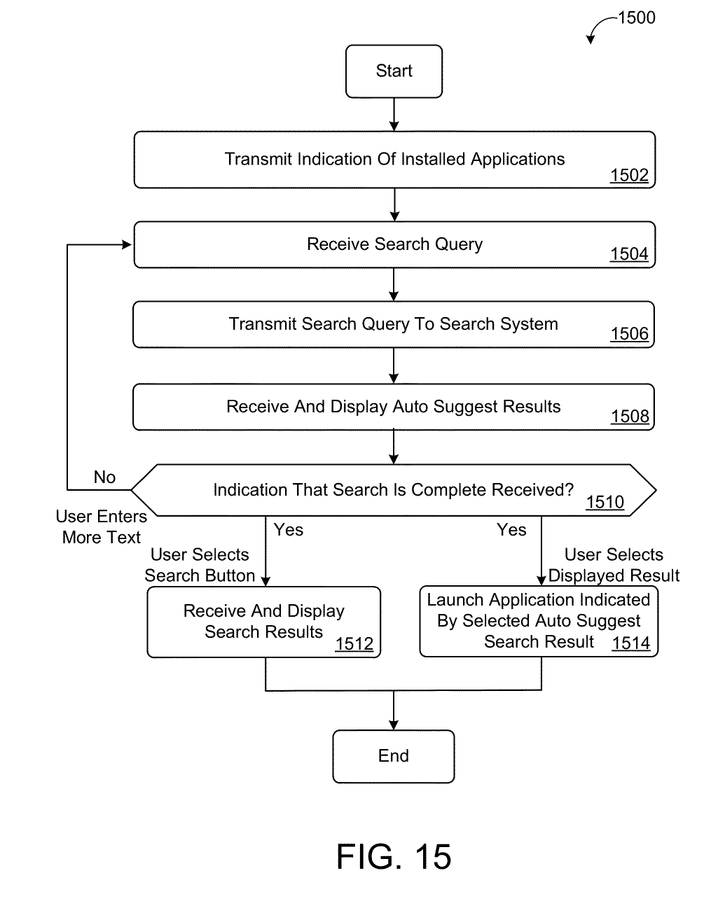

FIG. 15 illustrates an example method 1500 for retrieving auto-suggest results 220 from the search system 300 (including the auto-suggest module 410). At block 1502, the user device 200 transmits an indication of the applications 204a installed on the user device 200. The user device 200 may encode the list of installed application 229 in an array where each element identifies a native application 204a installed on the user device 200 or a more compact data structure, such as a Bloom filter that is indicative of a collection of native applications installed on the user device 200. At block 1504, the user device 200 receives a partial search query 212 from a user 10 of the user device 200 (e.g., as entered via the GUI search box 214). As was previously discussed, the search application 216 is configured to perform an incremental search. In an incremental search, each keystroke or set of keystrokes may prompt the user device 200 to transmit the partial search query 212 to the search system 300. Thus, at block 1506, the user device 200 transmits the received partial search query 212 to the search system 300 (including the auto-suggest system 400). At block 1508, the user device 200 receives auto-suggest results 220 from the search system 300. As described earlier, the search system 300 identifies one or more application states of the one or more installed applications 229 (e.g., application state IDs 332 of an application state record 330) based on the partial search query 212 inputted by the user 10 via the GUI search field 214 displayed on the screen 209 of the user device 200 and auto-suggest data 430 corresponding to the set of installed applications 229 on the user device 200. Therefore, the auto-suggest results 220 pertain to the applications 204 installed on the user device 200, thus providing the user 10 with a unique experience specific to her/his user device 200. For example, referring back to FIG. 9A, the user 10 may have two sports news applications 204 and a News application 204 (e.g., “Bay News”) installed on the user device 200. When the user 10 enters the query string “ear” into the search box 214, the displayed auto-suggest results 220 include user selectable links 230 pertaining to the applications 204 installed on the user device 200. As shown in the example, the first user-selectable link 230a provides access to a sports application having an article about the San Jose Earthquakes, the second user-selectable link 230b provides access to another sports application having a score of an on-going San Jose Earthquakes game, and the third user-selectable link 230c provides access to a news application having an article in the Bay News about “Earthquakes” (in this case that the Earthquakes team is trading a start player). If the user 10 had different applications 204 installed on the user device 200, the search system 300 would return different auto-suggest results 220 pertaining to application states of those installed applications 204, 229. At block 1510, the user device 200 determines if the user 10 has completed the search. Since the search system 300 executes an incremental search, the system 100 performs and narrows down the search with every input received by the GUI 240 from the user device 200. Thus, there are two ways that a user 10 can end a search executed by a search system 300. The user 10 can either select a search button 215 (or an analogous action) or the user 10 can select a displayed auto-suggested search result 220. In the former scenario (e.g., user selects search button 215), the user device 200 transmits the completed search query 212 to the search system 300. In response to receiving the search query 212, the search system 300 transmits search results 220 to the user device 200. Thus at block 1512, the user device 200 receives and displays the search results 220 as user-selectable links 230. In the latter scenario (e.g., the user 10 selects a displayed autosuggested search result 220), the user device 200 launches a native application 204a indicated by the selected result 220 and sets the state of the native application to the state indicated by the underlying access mechanism, as shown at block 1514. In the scenario where the user 10 continues to enter text, the method continues to execute (e.g., returns to 1504).

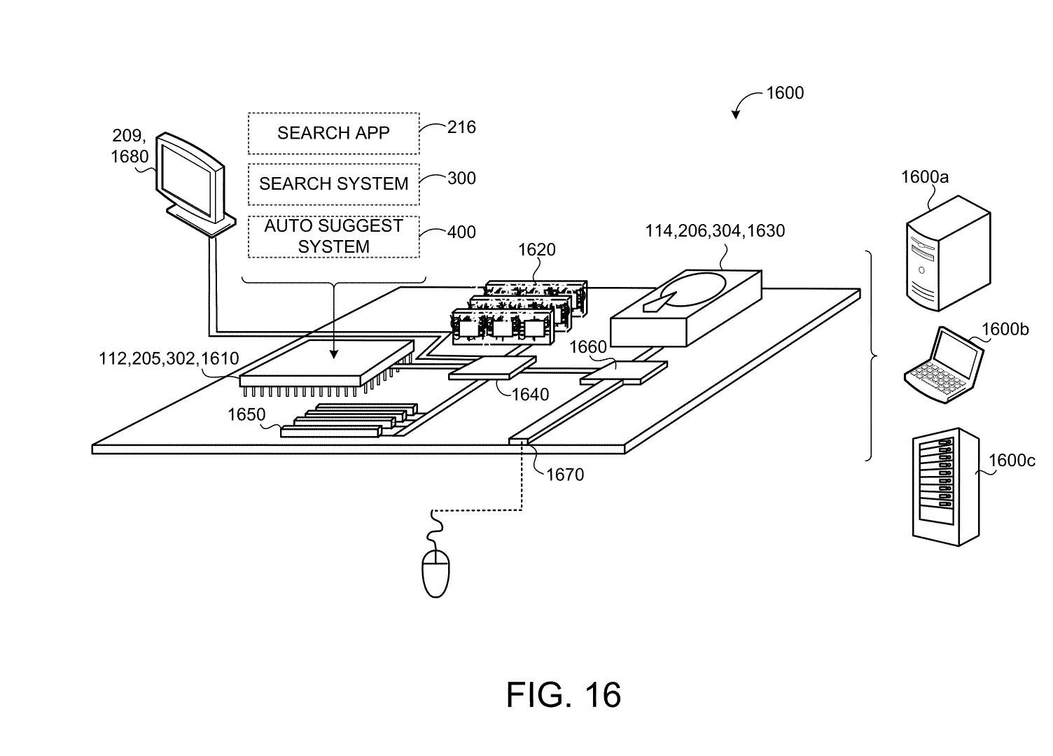

FIG. 16 is a schematic view of an example computing device 1600 that may be used to implement the systems and methods described in this document. The computing device 1600 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 1600 includes a processor 112, 205, 302, 1610, memory 1620, a storage device 114, 206, 304, 1630, a high-speed interface/controller 1640 connecting to the memory 1620 and high-speed expansion ports 1650, and a low speed interface/controller 1660 connecting to low speed bus 1670 and storage device 114, 206, 304, 1630. Each of the components 1610, 1620, 1630, 1640, 1650, and 1660, are interconnected using various busses, and may be mounted on a common motherboard or in other manners as appropriate. The processor 112, 205, 302, 1610 can process instructions for execution within the computing device 1600, including instructions stored in the memory 1620 or on the storage device 114, 206, 304, 1630 to display graphical information for a graphical user interface (GUI) on an external input/output device, such as display 1680 coupled to high speed interface 1640. In other implementations, multiple processors and/or multiple buses may be used, as appropriate, along with multiple memories and types of memory. Also, multiple computing devices 1600 may be connected, with each device providing portions of the necessary operations (e.g., as a server bank, a group of blade servers, or a multi-processor system).

The memory 1620 stores information non-transitorily within the computing device 1600. The memory 1620 may be a computer-readable medium, a volatile memory unit(s), or non-volatile memory unit(s). The non-transitory memory 1620 may be physical devices used to store programs (e.g., sequences of instructions) or data (e.g., program state information) on a temporary or permanent basis for use by the computing device 1600. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 114, 206, 304, 1630 is capable of providing mass storage for the computing device 1600. In some implementations, the storage device 114, 206, 304, 1630 is a computer-readable medium. In various different implementations, the storage device 114, 206, 304, 1630 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 1620, the storage device 114, 206, 304, 1630, or memory on processor 112, 205, 302, 1610.

The high speed controller 1640 manages bandwidth-intensive operations for the computing device 1600, while the low speed controller 1660 manages lower bandwidth-intensive operations. Such allocation of duties is exemplary only. In some implementations, the high-speed controller 1640 is coupled to the memory 1620, the display 1680 (e.g., through a graphics processor or accelerator), and to the high-speed expansion ports 1650, which may accept various expansion cards (not shown). In some implementations, the low-speed controller 1660 is coupled to the storage device 114, 206, 304, 1630 and low-speed expansion port 1670. The low-speed expansion port 1670, which may include various communication ports (e.g., USB, Bluetooth, Ethernet, wireless Ethernet), may be coupled to one or more input/output devices, such as a keyboard, a pointing device, a scanner, or a networking device, such as a switch or router, e.g., through a network adapter.

The computing device 1600 may be implemented in a number of different forms, as shown in the figure. For example, it may be implemented as a standard server 1600a or multiple times in a group of such servers 1600a, as a laptop computer 1600b, or as part of a rack server system 1600c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A method comprising:
receiving, at data processing hardware, an indication from a user device of one or more installed applications on the user device;
receiving, at the data processing hardware, a partial search query from the user device;
identifying, by the data processing hardware, one or more application states of the one or more installed applications based on the partial search query and auto-suggest data, the auto-suggest data associating application states of the one or more installed applications with keywords corresponding to the respective application states and at least partially based on content feed data corresponding to application states of the one or more installed applications, the content feed data being obtained from a plurality of different content feeds, each content feed being accessed by a crawler;
generating, by the data processing hardware, auto-suggest search results comprising one or more application access mechanisms of the identified one or more application states, each application access mechanism having a reference to a corresponding installed application and being configured to access the corresponding identified application state using the corresponding installed application; and
transmitting the auto-suggest search results from the data processing hardware to the user device.

2. The method of claim 1, wherein the content feed data comprises a set of documents obtained from the plurality of content feeds, each document corresponding to an application state of a respective application, being accessible using an application access mechanism corresponding to the application state, and defining content presented at the application state.

3. The method of claim 1, further comprising:
identifying, by the data processing hardware, the plurality of content feeds;
for each content feed:
creating, by the data processing hardware, a content feed record corresponding to the content feed, the content feed record defining an address from which to obtain newly published documents on the content feed;
periodically obtaining, by the data processing hardware, new documents from the content feed using the address defined in the content feed record;
for each new document:
identifying, by the data processing hardware, new content feed data defined in the document and a new application access mechanism corresponding to the new document;
identifying, by the data processing hardware, one or more keywords pertaining to the new document;
generating, by the data processing hardware, an application state record based on the new content feed data, and the new application access mechanism; and
updating, by the data processing hardware, the autosuggest data based on the application state record and the one or more keywords.

4. The method of claim 3, further comprising, for at least one new document:
scraping, by the data processing hardware, the new document to identify a title of the new document;
generating, by the data processing hardware, a second application access mechanism corresponding to a different application than the application that provides the new document based on an access mechanism template corresponding to the different application and the title obtained from the new document;
generating, by the data processing hardware, a second application state record corresponding to the different application based on the second application access mechanism; and
updating, by the data processing hardware, the autosuggest data based on the second application state record and the one or more keywords.

5. The method of claim 1, wherein the plurality of content feeds comprises one or more Rich Site Summary feeds.

6. The method of claim 1, wherein identifying the one or more application states of the one or more installed applications comprises searching an index of documents having name-value pairs for keywords containing or beginning with the partial search query, each name-value pair corresponding to a keyword, each document associated with an application state.

7. The method of claim 1, wherein identifying the one or more application states of the one or more installed applications comprises searching auto-suggest data blocks for keywords containing or beginning with the partial search query, each auto-suggest data block associating a keyword with an application state of a corresponding installed application.

8. The method of claim 7, wherein each auto-suggest data block associates a keyword with a document representing the corresponding application state of the corresponding installed application, the document comprising at least one of a document title, an application access mechanism for accessing the corresponding application state of the corresponding installed application, a keyword score indicating a degree of relevancy of the keyword to the document, or a document location.

9. The method of claim 8, wherein the application state of the corresponding auto-suggest data block is for accessing content of a content feed.

10. The method of claim 8, wherein identifying the one or more application states of the one or more installed applications comprises comparing the partial search query against one or more grammar sets to determine a relevancy of an application state, each grammar set comprising search grammars, each search grammar having a search expression in the form of modifier:argument, wherein the partial search query matches the expression of the search grammar when a condition specified by the modifier:argument is satisfied.

11. The method of claim 8, wherein each search grammar has an associated grammar score indicating the relevancy of the search grammar to the associated application state.

12. A method comprising:
receiving, at data processing hardware of a user device, auto-suggest data transmitted from a search system in communication with the data processing hardware, the auto-suggest data associating application states of one or more applications installed on the user device with keywords corresponding to the respective application states and at least partially based on content feed data corresponding to applications states of the one or more installed applications, the content feed data being obtained from a plurality of different content feeds, the content feeds being accessed by a crawler of the search system;
receiving, by the data processing hardware via a search field presented in a user interface of the user device, a partial search query at the data processing hardware;
identifying, by the data processing hardware, one or more application states of the one or more installed applications based on the partial search string and the auto-suggest data;
generating, by the data processing hardware, auto-suggest search results comprising one or more application access mechanisms of the identified one or more application states, each application access mechanism having a reference to a corresponding installed application and being configured to access the corresponding identified application state using the corresponding installed application; and
displaying, by the data processing hardware, the auto-suggest search results on the user interface of the user device.

13. The method of claim 12, wherein the content feed data comprises a set of documents obtained from the plurality of content feeds, each document corresponding to an application state of a respective application, being accessible using an application access mechanism, and defining content presented at the application state.

14. The method of claim 12, wherein identifying the one or more application states of the one or more installed applications comprises searching an index of documents having name-value pairs for keywords containing or beginning with the partial search query, each name-value pair corresponding to a keyword, each document associated with an application state.

15. The method of claim 12, wherein identifying the one or more application states of the one or more installed applications comprises searching auto-suggest data blocks for keywords containing or beginning with the partial search query, each auto-suggest data block associating a keyword with an application state of a corresponding installed application.

16. The method of claim 15, wherein each auto-suggest data block associates a keyword with a document representing the corresponding application state of the corresponding installed application, the document comprising at least one of a document title, an application access mechanism for accessing the corresponding application state of the corresponding installed application, a keyword score indicating a degree of relevancy of the keyword to the document, or a document location.

17. The method of claim 16, wherein the application state of the corresponding auto-suggest data block is for accessing content of a content feed.

18. The method of claim 16, wherein identifying the one or more application states of the one or more installed applications comprises comparing the partial search query against one or more grammar sets to determine a relevancy of an application state, each grammar set comprising search grammars, each search grammar having a search expression in the form of modifier:argument, wherein the partial search query matches the expression of the search grammar when a condition specified by the modifier:argument is satisfied.

19. The method of claim 16, wherein each search grammar has an associated grammar score indicating the relevancy of the search grammar to the associated application state.

20. The method of claim 12, further comprising periodically receiving the auto-suggest data from the search system and periodically transmitting, from the data processing hardware to the search system, an indication of the one or more applications installed on the user device.

21. The method of claim 12, further comprising:
receiving, by the data processing hardware via the user interface, one of:
a selection of one of the autosuggest search results; and
additional text via the search field and selection of a search execution command;
in response to selection of one of the autosuggest search results, accessing, by the data processing hardware, the application state indicated by the selected autosuggest search result using the application access mechanism corresponding to the selected autosuggest search result; and
in response to selection of the search execution command:
transmitting, by the data processing hardware, a search query indicating the partial search query and the additional text to the search system; and
receiving, by the data processing hardware, search results responsive to the search query.
